(19) United States
(12) Patent Application Publication
(10) Pub. No.: US 2026/0289303 A1
(43) Pub. Date: Sep. 24, 2026

(54) SYSTEM

(71) Applicant: SoftBank Group Corp., Tokyo (JP)

(72) Inventor: Takaya YAMAGUCHI, Tokyo (JP)

(73) Assignee: SoftBank Group Corp., Tokyo (JP)

(21) Appl. No.: 19/567,266

(22) Filed: Mar. 16, 2026

(30) Foreign Application Priority Data
Mar. 19, 2025 (JP) 2025-045242

(51) Int. Cl. G06N 3/08; G06N 3/0475; H04L 51/02

(52) U.S. Cl. CPC G06N 3/08; G06N 3/0475; H04L 51/02

(57) ABSTRACT

A system includes a processor that is configured to generate and input a prompt sentence to a generative AI model in order to instruct the generative AI model to generate a translation, acquire and analyze information from an overseas information provider, and recognize a user's emotion and adjust a translation result based on the recognized user's emotion.

### CROSS-REFERENCE TO RELATED APPLICATION

This application is based on and claims priority under 35 USC 119 from Japanese Patent Application No. 2025-045242 filed on Mar. 19, 2025, the disclosure of which is incorporated by reference herein.

### BACKGROUND

### Technical Field

The Present Disclosure Relates to a System.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional machine translation systems, including those utilizing generative AI models, generally focus on lexical and syntactic accuracy and do not sufficiently take into account the emotional state or preferences of the user who consumes the translation. As a result, even when the literal meaning of a source text is correctly translated, the translation may be perceived as inappropriate, unfriendly, or difficult to understand by a particular user, thereby reducing user satisfaction and comprehension. Furthermore, generative AI models tend to produce hallucinations or incorrect information, especially when processing ambiguous or incomplete input, and typical systems do not adequately control or optimize the model parameters or prompts to suppress such erroneous outputs. In addition, in many existing systems, the generation of translations is performed in a batch or offline manner, and real-time translation synchronized with the timing of information receipt is not sufficiently realized, which is problematic for applications requiring immediate access to translated content. Therefore, there is a need for a system that can dynamically generate prompts for a generative AI model, acquire and analyze information from overseas information providers, recognize the user's emotion, adjust the translation result in accordance with the recognized emotion, reduce the occurrence of incorrect information by optimizing model parameters, and perform real-time translation at the time of information reception.

### SUMMARY

In order to solve the above-described problems, the present invention provides a system comprising a processor, wherein the processor is configured to generate and input a prompt sentence to a generative AI model in order to instruct the generative AI model to generate a translation, acquire and analyze information from an overseas information provider, and recognize a user's emotion and adjust a translation result based on the recognized user's emotion. By generating a prompt sentence that explicitly specifies translation instructions, the processor can control the behavior of the generative AI model and guide the model to produce translations that are aligned with the source content and the user's emotional state. Moreover, the processor is configured to optimize parameters of the generative AI model so that the generative AI model has a characteristic of being less likely to generate incorrect information, thereby reducing hallucinations and improving the reliability of the translation output. In addition, the processor is configured to generate a prompt sentence for instructing the generative AI model to generate a translation in real time upon receipt of information and input the prompt sentence to the generative AI model, such that the system can provide translations substantially concurrently with the acquisition of information from the overseas information provider. Through these means, the system can deliver user-adaptive, low-hallucination translations in real time, thereby improving usability, accuracy, and responsiveness compared to conventional systems.

The term “system” refers to an integrated combination of hardware and software components, including at least one processor and any associated memory, storage, communication interfaces, and programs, that cooperatively perform the translation-related processing described in the claims.

The term “processor” refers to any electronic data processing unit, such as a CPU, GPU, ASIC, FPGA, or a combination thereof, that executes instructions to perform the generation of prompts, the acquisition and analysis of information, the recognition of user emotion, the adjustment of translation results, and the optimization of generative AI model parameters.

The term “generative AI model” refers to a machine learning model, such as a neural network trained on large-scale text data, that is capable of generating natural language output, including translations, in response to input text and control signals such as prompts and parameters.

The term “prompt sentence” refers to a text string or a structured textual instruction that is generated by the processor and provided to the generative AI model in order to control or guide the behavior of the generative AI model when generating a translation.

The term “translation” refers to a natural language text generated by the generative AI model in a target language based on an input text in a source language, where the translation is intended to preserve at least the main meaning or content of the input text.

The term “overseas information provider” refers to an entity, such as a content provider, news agency, web service, or data source located in a foreign region or country, that supplies original information or articles in a source language to the system.

The term “acquire and analyze information” refers to operations in which the processor receives information from an overseas information provider via a communication interface, and then performs processing such as parsing, segmenting, metadata extraction, language detection, content classification, or other analytical procedures on the received information.

The term “user's emotion” refers to an emotional state of a user, such as happiness, sadness, anger, anxiety, or calmness, which is recognized or estimated by the processor based on input signals, including but not limited to user interactions, textual feedback, voice tone, facial expressions, or physiological data.

The term “recognize a user's emotion” refers to processing by which the processor determines or estimates the user's emotional state, for example by applying a rule-based method or a machine learning model to input data associated with the user.

The term “adjust a translation result” refers to processing by which the processor modifies, selects, filters, reorders, or regenerates all or part of a translation generated by the generative AI model, such that the style, tone, politeness level, directness, or other characteristics of the translation are adapted in accordance with the recognized user's emotion.

The term “optimize parameters of the generative AI model” refers to modifying one or more model-related settings, including but not limited to weights, hyperparameters, decoding parameters, temperature, top-k or top-p values, or prompt configuration, in order to improve the model's performance, for example by reducing the likelihood of generating incorrect or hallucinated information.

The term “characteristic of being less likely to generate incorrect information” refers to a property of the generative AI model, achieved through parameter optimization or other control techniques, in which the model tends to reduce hallucinations, fabrication of facts, or factual errors in generated translations, relative to a model without such optimization.

The term “incorrect information” refers to content generated by the generative AI model that does not accurately reflect the source text or real-world facts, including hallucinated entities, fabricated details, or misrepresented data that are not supported by the input information.

The term “real time upon receipt of information” refers to a timing relationship in which the processor initiates translation processing substantially immediately after receiving information from the overseas information provider, with only processing delays that are inherent to the execution of the translation and without intentional long-term storage or batch scheduling prior to translation.

The term “input the prompt sentence to the generative AI model” refers to providing the generated prompt sentence, together with any associated translation request data, to the generative AI model via an application programming interface, function call, or other communication mechanism, so that the model uses the prompt sentence when generating a translation.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

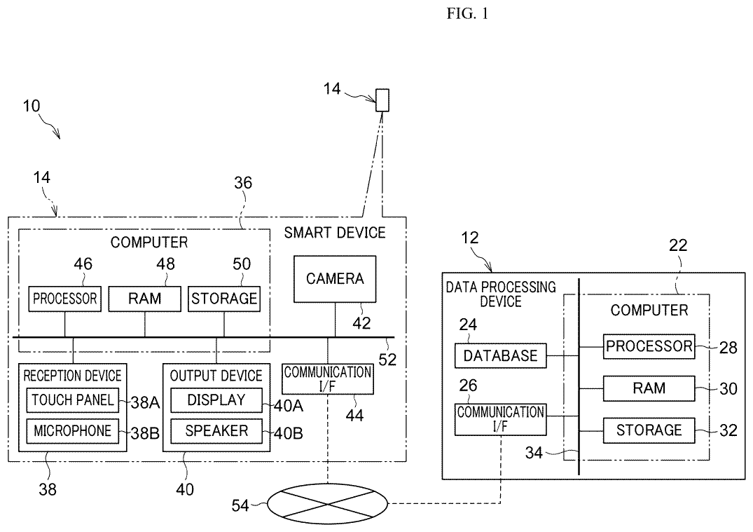

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

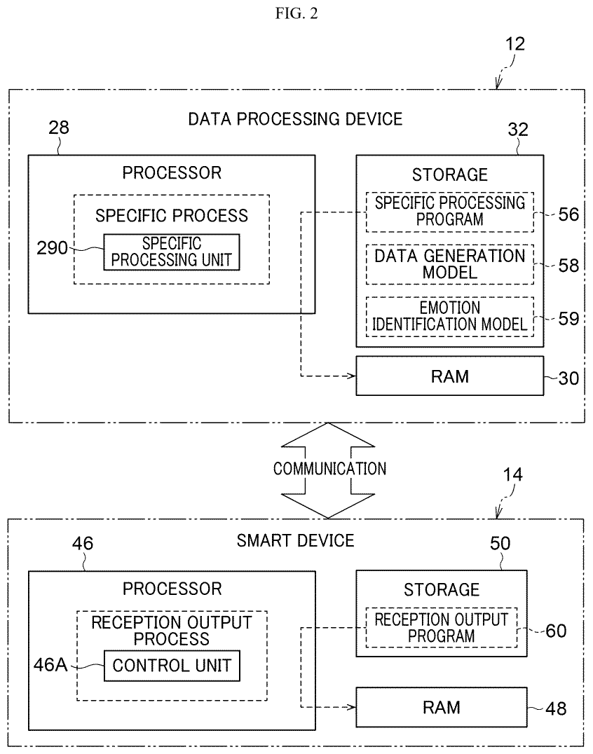

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented translation systems that utilize machine learning models or rule-based engines are typically designed as linear pipelines: source text is received, a translation engine is invoked, and the translated output is returned or stored. In such architectures, the translation component is largely treated as a black box, and the surrounding software logic merely forwards text and retrieves output. As a result, several technical problems arise in the operation of information processing apparatuses and communication networks.

First, conventional systems lack a mechanism for dynamically generating and controlling prompt sentences or equivalent instruction data for a generative AI model in a manner tightly integrated with upstream data acquisition and downstream storage and delivery processes. The prompt content is often static or manually configured, which causes suboptimal utilization of model capabilities, inefficient use of computational resources, and inconsistent translation quality when the system operates at scale on heterogeneous input streams from various external information sources.

Second, conventional systems generally do not maintain a structured, machine-enforced association between original information and translated information within storage architectures. Without explicit linking of original and translated records at the database schema and access layer, server-side retrieval logic becomes complex and error-prone, resulting in inefficient query processing, increased latency for user terminals, and difficulty in presenting synchronized original and translated views to end users.

Third, most existing translation platforms provide only a unidirectional output channel to a user terminal, where the translated text is rendered without coordination between original and translated forms. This limits the ability of the client-side processing logic to render parallel or switchable views of the two versions using a unified interface protocol. Consequently, the user interface layer cannot reliably offer synchronized comparison, and users may experience confusion or reduced trust in the translation, which in turn diminishes the practical effectiveness of the computer-implemented translation process.

Fourth, conventional systems do not incorporate user-specific emotional state or reaction information into the control logic of the translation pipeline. Even when user feedback is collected, it is often handled outside the real-time processing path and is not used to adapt prompt sentence generation, output format selection, or generative AI model control parameters. This results in a static interaction model in which the server cannot technically adjust its behavior based on runtime user signals, leading to less effective content presentation and an increased risk that misunderstood or emotionally sensitive translations will persist in the system.

Fifth, the handling of misinformation in existing systems is generally addressed at the application-policy level (for example, manual moderation or external filters) rather than at the level of computer control of the generative AI model. There is no integrated mechanism that configures model control parameters, operation setting values, or prompt structures based on runtime statistical information and evaluation data to reduce the probability of misinformation being generated during the core translation operation itself. This leads to a system architecture that is vulnerable to propagation of incorrect content and requires additional downstream corrective processing.

Sixth, conventional systems often perform translation as a batch process, with limited support for real-time or near-real-time translation at the moment information is received from external sources. The lack of a server-side mechanism to automatically generate and issue appropriate prompt sentences at the time of reception, and to stream or sequentially input text segments to a generative AI model, causes increased end-to-end latency and prevents timely delivery of translated information to user terminals. This adversely affects the performance and responsiveness of the overall computer system, especially when dealing with high-volume, continuously updated foreign information feeds.

Accordingly, there is a need for an improved computer-implemented translation system and server architecture that (i) programmatically generates and manages prompt sentences for a generative AI model in coordination with data acquisition and storage, (ii) structurally associates original and translated content in a storage device for efficient retrieval, (iii) supports coordinated parallel or switchable display of the two forms at a user terminal, (iv) utilizes user emotional state or reaction information to adapt translation control, (v) configures generative model control parameters based on statistical and evaluation information to reduce misinformation at the model level, and (vi) enables real-time translation processing initiated at the moment of data reception. Such improvements constitute enhancements to computer technology itself, by providing more effective server-side control of generative AI models, more efficient data structures and retrieval mechanisms, and more responsive client-server interaction patterns.

The specific processing by the specific processing unit 290 of the data processing device 12 in Example 1 is realized by the following means.

The present invention provides a server comprising a processor configured to generate, for each item of character information acquired from an external information source, a prompt sentence that instructs a generative information processing apparatus to execute translation processing, to input the prompt sentence and the character information into the generative information processing apparatus, to receive translation information output by the generative information processing apparatus, to associate the translation information with corresponding original information in a structured storage architecture of a storage device, to control transmission of both the original information and the translation information to an information browsing terminal such that the information browsing terminal can perform parallel or switchable display of the original information and the translation information, to analyze emotional state information or reaction information relating to a user entity who operates the information browsing terminal, to adjust at least one of a content of the prompt sentence and an output format of the translation information based on a result of the analysis, and to set at least one of a description content of the prompt sentence, a control parameter, and an operation setting value of the generative information processing apparatus based on operation characteristics, statistical information, or evaluation information of the generative information processing apparatus so as to reduce a probability that misinformation will be generated, and to automatically generate, at a time of reception or immediately after reception of the character information from the external information source, a prompt sentence for causing real-time execution of translation processing and sequentially input the prompt sentence and the character information into the generative information processing apparatus. This enables the computer-implemented translation system to optimize operation of the generative information processing apparatus at the server level, to maintain an explicit association between original and translated information in the storage device for efficient retrieval, to provide coordinated parallel or switchable presentation of the two forms at the information browsing terminal, to dynamically adapt translation control behavior based on user emotional feedback, to technically suppress generation of misinformation through parameter and prompt control in the generative information processing apparatus, and to deliver real-time or near-real-time translation results in response to incoming external information, thereby improving performance, reliability, and functionality of the underlying computer technology.

The term “processor” refers to a hardware circuit or a combination of hardware and software, including at least one central processing unit or equivalent execution unit, that executes program instructions to perform data processing operations described in this specification.

The term “generative information processing apparatus” refers to an information processing system, including at least one machine learning model such as a generative AI model, that generates or transforms information (including natural language text) in response to input data and control information including a prompt sentence.

The term “generative AI model” refers to a data-driven computational model, such as a neural network model, that has been trained on training data to generate output information, including natural language text, based on input information and control parameters.

The term “prompt sentence” refers to a data string or structured instruction, including natural language content or control tokens, that is supplied to the generative information processing apparatus to specify a task, a style, a target language, or other processing conditions for generating translation information.

The term “character information” refers to information composed of symbols, characters, or encoded text data, including words, sentences, and documents represented in one or more natural languages in a machine-readable format.

The term “external information source” refers to an information providing entity, including an information processing apparatus or a server controlled by a third party, that transmits character information to the server via a communication network.

The term “communication network” refers to an arrangement of communication lines and nodes, including at least one wired or wireless network such as the Internet or a local area network, that enables data exchange between the server, the external information source, and the information browsing terminal.

The term “internal format” refers to a data representation form used inside the server, including data structures such as records, objects, or messages, into which received character information is converted for storage and processing.

The term “original information” refers to character information received from the external information source prior to translation processing by the generative information processing apparatus.

The term “translation information” refers to character information in a target language generated by the generative information processing apparatus based on the original information and control information including a prompt sentence.

The term “storage device” refers to a physical or virtual data storage unit, including at least one memory device or nonvolatile storage device, that stores original information, translation information, metadata, and associated control data.

The term “information storage structure” refers to a logical organization of data within the storage device, including tables, records, indexes, files, or other data structures, that define how original information and translation information are associated and stored.

The term “information browsing terminal” refers to an information processing apparatus operated by a user entity, including at least one computing device such as a personal computer, a tablet device, or a mobile communication device, that receives and displays original information and translation information transmitted from the server.

The term “display screen” refers to a graphical user interface presentation, including one or more visual regions rendered on a display device of the information browsing terminal, that shows original information, translation information, user interface elements, and control components.

The term “parallel display” refers to a mode of display in which at least part of the original information and at least part of the translation information are simultaneously presented on the display screen so that a user entity can view the two forms together.

The term “switchable display” refers to a mode of display in which at least one user operation causes the display screen to switch between showing the original information and showing the translation information, or to toggle visibility of these forms.

The term “user entity” refers to a human user or an organizational user represented by an operator, who interacts with the information browsing terminal and provides inputs, including selection operations and reaction information.

The term “selection operation” refers to an input action performed by the user entity, including operations such as clicking, tapping, touching, or keyboard entry, by which the user entity selects content, display modes, or commands presented on the display screen.

The term “emotional state” refers to a condition of affect or sentiment of the user entity, such as satisfaction, confusion, or frustration, which is inferred based on signals including reaction information, interaction patterns, or explicit feedback.

The term “reaction information” refers to data that represents a response of the user entity to displayed information, including explicit feedback (such as ratings, comments, or selections) and implicit behavioral data (such as viewing time, scrolling behavior, or interaction frequency).

The term “output format of the translation information” refers to a manner in which the translation information is structured, arranged, or presented, including layout, detail level, style, or additional explanatory elements applied before transmission to the information browsing terminal.

The term “operation characteristics” refers to measurable performance attributes of the generative information processing apparatus, including accuracy, latency, error rate, and response patterns, obtained from operation logs, statistics, or evaluation results.

The term “control parameter” refers to a setting or variable that influences the internal behavior of the generative information processing apparatus, including but not limited to temperature values, decoding parameters, generation length limits, or filtering thresholds.

The term “operation setting value” refers to a configurable parameter or mode of operation in the generative information processing apparatus or in the server's control logic, including model selection, resource allocation policies, or triggering conditions for translation processing.

The term “statistical information” refers to aggregated numerical data derived from operation records of the generative information processing apparatus or the server, including counts, averages, distributions, or other statistical measures relating to outputs and errors.

The term “evaluation information” refers to assessment data that represents quality or reliability of outputs of the generative information processing apparatus, including human-annotated scores, automated quality metrics, or external validation results.

The term “misinformation” refers to information that is factually incorrect, misleading, or inconsistent with reliable reference data, and that is produced or propagated through operation of the generative information processing apparatus or related processing.

The term “real-time execution of translation processing” refers to translation processing that is initiated and performed substantially immediately upon reception of character information from the external information source, with latency constrained so that translated results are available without a perceptible delay in typical system operation.

The term “sequentially input” refers to a mode of providing the prompt sentence and the character information to the generative information processing apparatus in one or more ordered portions, such that the apparatus can begin or continue translation processing while the reception of subsequent portions is still in progress.

In one embodiment, a server is implemented as a computer apparatus including at least one processor, a main memory, a nonvolatile storage device, a network interface, and an operating system. The server uses general-purpose server hardware such as a multi-core central processing unit, a volatile memory device, and a solid-state drive, and runs server software such as a web server program, an application framework, and a database management system. For example, the server uses a web server program (such as an HTTP server), an application framework (such as a scripting framework for handling HTTP requests), and a relational database management system (such as a general-purpose SQL engine). The server communicates over a communication network such as the Internet or a local area network by means of the network interface.

The server stores program modules in the nonvolatile storage device. The processor of the server loads the program modules into the main memory and executes them to implement multiple functional units, including a data acquisition unit, a prompt generation unit, a generative AI interaction unit, a storage management unit, a user analysis unit, and a delivery control unit. Each of these units is realized by executing computer-readable instructions that cause the processor to perform specific data processing operations on structured data stored in memory.

The server uses a generative AI model that is implemented as a neural network model deployed on a remote or local generative information processing apparatus. In one embodiment, the generative AI model is a transformer-based neural network that includes an input embedding layer, multiple self-attention layers, feed-forward layers, and an output layer. The generative AI model receives tokenized sequences of symbols representing prompt sentences and original text and outputs tokenized sequences representing translated text. The generative AI model has parameters including weight matrices and bias vectors associated with each layer, and decoding parameters such as temperature, top-k and top-p sampling thresholds, maximum token length, and repetition penalties. The generative AI model has been trained using a supervised learning method with backpropagation, where an error function such as a cross-entropy loss between predicted tokens and reference tokens is minimized using a gradient-based optimizer.

The server interacts with the generative AI model via an application programming interface.

The server sends a prompt sentence and character information encoded as text to the generative information processing apparatus over a secure communication channel. The server receives the generated translation information as a text response. This interaction is not limited to simple pass-through forwarding; instead, the server dynamically constructs and modifies prompt sentences, sets or adjusts control parameters for the generative AI model, and structures the input and output according to internal data schemas. This control yields improved translation quality, reduced generation of misinformation, and more efficient resource utilization.

The server acquires character information from an external information source. The server uses the data acquisition unit to listen for incoming requests from external systems via HTTP, HTTPS, or other protocols. When the server receives a data payload containing character information (for example, an article text in a foreign language, title, and metadata), the server parses the payload, normalizes encoding (for example, to UTF-8), and transforms the data into an internal format such as a JSON-like object or a structured record. The server then stores the internal representation in the main memory and, optionally, logs metadata in a message queue system. The server assigns a unique identifier to the acquired character information and associates it with source attributes (such as a language code, provider identifier, and topic category).

The server generates a prompt sentence using the prompt generation unit. The server retrieves configuration data that defines translation objectives, such as source and target language pairs, formality level, terminology treatment, and length constraints. Based on this configuration, the server assembles a prompt sentence as a text string. For example, the server generates a prompt sentence such as:

“Translate the following article from English to Japanese. Output only the Japanese translation in natural and fluent style: [article body].”

In another example, the server generates a more specialized prompt sentence such as:

“You are a professional technical translator. Translate the following English technology article into Japanese. Preserve product names and technical terms in English when appropriate: [article body].”

In still another example, the server generates a prompt sentence that instructs summarization plus translation:

“Summarize the following French article in about five sentences and then translate the summary into Japanese. Output only the final Japanese summary: [article body].”

The server embeds the original character information into the prompt sentence at a specified position and ensures that the combined text does not exceed a predetermined token limit. The server can generate different templates of prompt sentences according to classification of the source content, user preferences, or system rules.

The server uses the generative AI interaction unit to communicate with the generative AI model. The server converts the prompt sentence and original character information into token sequences using a tokenizer corresponding to the generative AI model. The server sets control parameters (for example, temperature, maximum output tokens, and sampling options) based on internal policies that aim to reduce misinformation. For instance, the server decreases the temperature parameter and restricts the maximum token length for certain content categories to encourage more deterministic and concise outputs. The server then sends the tokenized data and control parameters to the generative information processing apparatus using a network protocol.

The generative AI model processes the input by encoding the tokens into embeddings, applying multiple layers of self-attention and feed-forward transformations, and computing a probability distribution over possible output tokens at each step. The generative AI model generates a sequence of output tokens representing the translated text. The generative information processing apparatus returns the sequence to the server. The server decodes the output tokens back into text and performs post-processing operations such as trimming whitespace, normalizing punctuation, and validating the character encoding.

The server uses the storage management unit to maintain an explicit association between original information and translation information. The server defines a data schema in the relational database that includes at least a translation table having fields such as a record identifier, source language code, target language code, original text, translated text, prompt identifier, model configuration, quality metrics, and timestamps. The server executes SQL commands to insert or update records so that each record includes both the original text and its corresponding translated text. The server also creates indexes on selected fields (for example, language codes, topic categories, timestamps, and provider identifiers) to optimize retrieval operations. By organizing the data in this structured way, the server reduces the complexity of query logic and decreases the time required to retrieve paired original and translated content.

The server provides translation information to an information browsing terminal. The server receives a request from the terminal that specifies, for example, a desired record identifier or search condition. The server queries the database using efficient SQL queries that leverage the indexes and the structured association between original and translated texts. The server retrieves the corresponding original text and translation text and generates a response that includes both versions, along with metadata for display control (such as available display modes and user interface hints). The server sends the response to the terminal over the communication network.

The terminal is implemented as a client computing device such as a personal computer, a tablet, or a mobile device. The terminal includes a processor, memory, a display, input devices, and a communication interface. The terminal runs client software such as a web browser or a dedicated application. Upon receiving data from the server, the terminal parses the response and constructs a display screen that presents original information and translation information in parallel or as switchable views. For example, the terminal displays the translation information in a main pane and the original information in a side pane, or places both texts in vertically aligned regions. Alternatively, the terminal displays only the translation text by default and provides a toggle control that, when activated by the user, reveals or hides the original text.

The user operates the terminal to select articles, control display modes, and provide feedback.

The user interacts with buttons, menus, or touch gestures to switch between parallel display and single-language display. The user may indicate perceived quality or trust in the translation by selecting rating options or inputting comments. The user may also exhibit implicit reactions, such as quickly abandoning an article or spending extended time on certain paragraphs. The terminal captures these explicit and implicit reactions and transmits reaction information to the server.

The server uses the user analysis unit to process emotional state information and reaction information. The server aggregates reaction data across sessions and users, computes metrics such as average reading time, bounce rate, and frequency of requests for original language display, and uses these metrics as features for estimating user emotional state. The server may classify states such as confusion, satisfaction, or distrust based on thresholds or machine-learned classification models. The server then modifies subsequent prompt generation and output formatting accordingly. For instance, if the server detects that users frequently request the original text for a particular topic category, the server may instruct the generative AI model via prompt conditions to provide more literal translations with additional explanatory phrases for that category.

The server adjusts control parameters of the generative AI model based on statistical information and evaluation information. The server maintains logs that include for each translation: model configuration, prompt type, error reports, and user feedback. The server periodically analyzes these logs to compute statistical information such as the rate of post-editing, user corrections, or flagged misinformation incidents. Based on this analysis, the server updates thresholds, content filters, decoding parameters, or model selection rules. For example, the server may reduce the temperature and enforce stricter length limits for domains with higher misinformation risk, or switch to a more conservative model variant when historical evaluation scores indicate lower reliability. This adaptive control improves the likelihood that the generative AI model produces accurate translations and reduces misinformation.

The server implements these adjustments using explicit rules and non-standard control flows that differ from simple human workflows. Instead of merely replicating human translation and review steps, the server configures the generative AI model to operate within a constrained output space defined by algorithmic rules, statistical thresholds, and automated pattern recognition in reaction data. This yields technical effects such as reduced variance in model outputs, lower error rates, and more stable performance across different content sources, which are achieved by specific computer-executed algorithms and parameter control mechanisms.

The server supports real-time or near-real-time translation. When the server receives character information from the external information source, the server immediately generates a prompt sentence tailored for real-time processing. For example, the server uses a prompt sentence such as:

“Translate the following incoming text from English to Japanese in real time. Output concise and accurate Japanese, without commentary: [incoming text].”

The server streams segments of the character information and sequentially inputs the segments and updated prompt contexts to the generative AI model. The generative AI model can begin producing translation tokens while later portions of the source text are still being received. The server forwards these partially translated results to the terminal, which can display them incrementally. This streaming architecture reduces end-to-end latency and improves responsiveness, enabling the user to access translated content almost immediately after it is published by the external information source.

The server also reduces communication and computation load by using caching and deduplication strategies. The server detects repeated source content or overlapping segments, stores precomputed translation results, and reuses them when identical or similar input reappears. The server can also limit the number of tokens sent to the generative AI model by truncating or summarizing non-essential parts via pre-processing algorithms before translation. These pre-processing algorithms are executed as concrete steps operating on structured text segments, not as abstract business procedures, and involve token count calculation, segmentation, and keyword extraction using established computational methods.

The described configuration improves computer technology in multiple ways. The explicit association of original and translated texts in a structured database reduces the number of queries and joins needed to fetch paired content, thereby decreasing response time. The dynamic generation and control of prompt sentences and model parameters, based on statistical and evaluation data, lowers the error rate of generated translations and decreases the amount of corrective processing required. The real-time streaming translation mechanism reduces latency and network overhead by controlling data granularity and avoiding redundant transmissions. The integration of user emotional state analysis into prompt and format control enables the server to automatically adapt its behavior, which improves user-perceived quality and decreases unnecessary repeated requests and re-downloads, thereby optimizing network and processing resources.

Alternative embodiments are possible. In one variation, the generative AI model is deployed locally on the same hardware as the server, using a graphics processing unit for accelerated matrix calculations, instead of being accessed via a remote API. In another variation, the database is implemented as a document-oriented database rather than a relational database, and the association between original and translated texts is represented via document references and embedded objects. In another variation, the user analysis unit uses a dedicated machine learning classifier trained on reaction logs to infer emotional state, rather than rule-based thresholds. In each variation, the server continues to perform prompt sentence generation, parameter adjustment, structured storage, and synchronized delivery to terminals in accordance with the claims.

In still another embodiment, the terminal includes local processing logic that can request alternative prompt types from the server. For example, the terminal may present the user with options such as “more literal translation” or “simplified explanation,” and send corresponding indicators to the server. The server then incorporates these indicators into the prompt sentence, such as:

“Translate the following Japanese article into English in a simple style suitable for non-experts. Avoid technical jargon where possible: [article body].”

By structurally modifying prompt sentences based on real-time user input and reaction information, the system achieves technical improvements in the flexibility and precision of translation behavior, realized by specific interactions between modules, data structures, and trained neural network models.

Through these embodiments and variations, the server, the terminal, and the user cooperate to realize a computer-implemented translation system in which data structures, processing algorithms, and neural network control mechanisms are concretely specified and configured to yield improved processing speed, accuracy, misinformation suppression, and overall system efficiency, rather than merely automating human linguistic tasks.

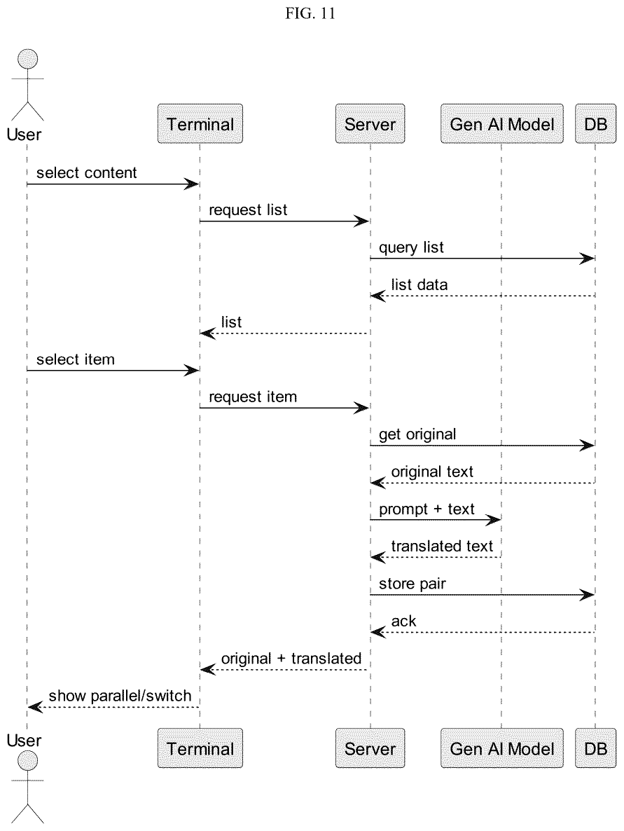

The following describes the processing flow using FIG. 11.

### Step 1:

Server receives character information from an external information source.

Server accepts an incoming request over a communication network, for example an HTTP or HTTPS POST request, containing character information such as an article body, a title, a language code, and metadata. As input, the server obtains a raw data payload in a network message format. Server parses the headers and body, decodes the payload from a transfer format such as JSON or XML into internal variables, and normalizes the character encoding to a unified format such as UTF-8. Server validates that required fields (for example, text content and source language) are present and that the data length is within preset limits. As a result of this data conversion and validation, the server outputs an internal data structure, such as a record or object, that represents the original information together with its metadata and a newly generated unique identifier.

### Step 2:

Server stores the received original information in a temporary storage area and logs metadata.

Server uses the internal data structure from Step 1 as input. Server writes key fields, such as the unique identifier, provider identifier, and timestamps, into a log table or a message queue, and may store the full text in a temporary buffer in main memory. Server uses a timestamp function to record the exact reception time and associates this with the unique identifier.

Server performs simple preprocessing operations such as trimming unnecessary whitespace and removing invalid characters. The output of this step is a cleaned and normalized original text object, stored in memory with an associated record in a temporary or staging area in a storage device, ready for translation processing.

### Step 3:

Server determines translation parameters and selects a generative AI model configuration.

Server takes as input the cleaned original text object and its metadata, including the source language, target language preference, content category, and provider attributes. Server consults configuration tables or rule sets stored in the database to decide which generative AI model variant, decoding parameters (such as temperature, maximum token count, top-k, top-p), and safety filters to apply. Server may also refer to historical statistical information and evaluation scores to adjust these parameters. Server performs data lookup and comparison operations, such as matching content category to a parameter profile and comparing reliability scores to thresholds. The output is a model configuration object that includes the selected model identifier, control parameters, and flags indicating special handling, for example stricter constraints for high-risk domains.

### Step 4:

Server generates a prompt sentence for translation.

Server receives as input the cleaned original text and the model configuration object from Step 3. Server selects a prompt template from a set of stored text templates based on the source language, target language, and content category. For example, for a technology article, the server may select a template such as:

“You are a professional technical translator. Translate the following English technology article into Japanese. Preserve product names and technical terms in English when appropriate: [article body].”

Server programmatically replaces the placeholder “[article body]” with the actual original text, and may inject additional control instructions such as desired formality level or length constraints. Server concatenates these elements into a single prompt sentence string. Server then calculates the approximate token count using a tokenizer function and, if necessary, truncates or segments the original text so that the combined prompt and text do not exceed a defined token limit. The output of this step is a finalized prompt sentence text and, if segmentation is applied, a list of text segments each with an associated prompt.

### Step 5:

Server tokenizes the prompt sentence and prepares a request to the generative AI model.

Server uses the finalized prompt sentence (or segment-specific prompt) and model configuration as input. Server invokes a tokenizer corresponding to the generative AI model to convert the prompt sentence from a string into a sequence of token identifiers. Server also encodes control parameters (such as temperature and maximum output tokens) into a request structure. Server packages the token sequence and control parameters into a formatted request suitable for the generative information processing apparatus, including any required authentication data. The data processing here includes mapping individual characters and words to token IDs, computing token sequence length, and structuring data fields according to an API schema. The output is a serialized request object ready for transmission to the generative AI model.

### Step 6:

Server sends the request to the generative AI model and receives translated tokens.

Server takes the serialized request object from Step 5 as input. Server opens a secure communication channel to the generative information processing apparatus and transmits the request. Server waits for the response, reading incoming bytes from the network interface and assembling them into a complete response message. Inside the generative AI model, token probabilities are computed layer by layer; however, from the server's perspective, the input is the request and the output is a response containing a sequence of translated token identifiers or text segments. Server parses the response, extracts the translated token sequence or text, and verifies integrity (for example, by checking that the sequence is not empty and that the length is within expected bounds). The output of this step is a raw translation string or a token sequence representing the translation.

### Step 7:

Server post-processes the translated text.

Server uses the raw translated text or token sequence from Step 6 as input. If the response is token-based, server detokenizes it into a human-readable text string. Server then applies post-processing rules such as trimming leading and trailing whitespace, normalizing punctuation, unescaping special characters, and replacing inappropriate symbols according to language-specific rules. Server may also run simple consistency checks, for example ensuring that numerical values and dates match between the original and translated texts. The server may tag the translation with a quality indicator if any anomalies are detected. The output is a cleaned translated text string that is ready for storage.

### Step 8:

Server stores original and translated information in a structured storage device.

Server takes as input the original text object from Step 2, the cleaned translated text from Step 7, and associated metadata such as language codes, provider identifiers, prompt template identifiers, and model configuration used. Server opens a connection to the database management system and executes commands to insert a new record into a translation table. Server populates fields including record identifier, source language, target language, original text, translated text, timestamps, prompt type, and model parameters. Server also updates index structures to allow efficient searching by language, category, and date. The data processing here includes mapping in-memory data fields to database columns and performing referential integrity checks. The output of this step is a persistent record associating the original and translation information, which can be retrieved by future queries.

### Step 9:

Server receives a retrieval request from a terminal.

Terminal sends, as input to the server, a retrieval request that may include a record identifier, a search keyword, a category filter, or other parameters indicating which information the user wishes to view. Server parses the request, validates the parameters, and constructs a query plan for the database. The input to this step is the user's request message; the output is a structured database query specification that indicates which tables and fields should be accessed to retrieve matching original and translation pairs.

### Step 10:

Server retrieves associated original and translated content for display.

Server uses the query specification from Step 9 as input. Server executes the query against the relational database, using indexes to locate records that match the criteria. Server reads the selected rows, extracting original text, translated text, language codes, titles, and other metadata. Server may perform additional processing such as sorting or limiting the number of records based on pagination parameters supplied by the terminal. The server then constructs a response structure including the paired original and translation texts for each record. The output of this step is a data package containing one or more original-translation pairs formatted for delivery to the terminal.

### Step 11:

Terminal receives content and renders parallel or switchable display.

Terminal accepts, as input, the data package from the server that includes original text, translated text, and display-related metadata. Terminal parses the data, assigns it to internal variables, and constructs user interface elements such as text areas, tabs, or toggle buttons.

Terminal generates a logical layout where the translated text is displayed in a primary area and the original text is displayed either alongside or hidden behind a switch. Terminal draws these elements on the display and attaches event handlers so that user actions can toggle between viewing modes. The output of this step is a rendered display screen that presents the paired information and is ready for user interaction.

### Step 12:

User interacts with the terminal to select content and provide reactions.

User views the rendered screen, scrolls through the content, and may switch between the original and translated views by performing interactions such as clicking a button or tapping a tab. As input, the user receives visual information, and outputs interaction events such as selection of an article, choice of display mode, rating of translation quality, or entry of comments. User generates reaction information through explicit actions (for example, pressing a “This translation is unclear” button) and implicit behavior (for example, quickly leaving a page). These interaction events are captured by the terminal as structured data, which the terminal sends to the server for analysis.

### Step 13:

Server analyzes reaction information and infers user emotional state patterns.

Server receives, as input, reaction information and interaction logs from the terminal. Server aggregates these data over time, associating them with corresponding articles, translations, and prompt types. Server computes metrics such as average read duration, frequency of toggling to the original text, and distribution of explicit ratings. Server applies classification rules or a trained classifier model to estimate emotional states, such as confusion or satisfaction, for particular combinations of content type and translation configuration. The output is a set of inferred emotional state indicators and performance metrics that the server stores in a statistical database and uses for future control decisions.

### Step 14:

Server updates prompt generation rules and model control parameters based on statistics.

Server uses the emotional state indicators and performance metrics from Step 13 as input. Server compares these metrics against predefined thresholds and decision rules. For example, if a high confusion rate is detected for a certain category, the server may decide to adjust prompt templates for that category to request more literal translations or additional explanations. Server updates internal configuration tables that map content categories and user profiles to prompt templates and model parameter sets. The data processing here includes conditional branching, parameter adjustment, and persistence of updated configuration states. The output is a revised configuration set that will be used for subsequent translation requests, thereby closing the feedback loop.

### Step 15:

Server handles real-time translation for newly received information.

Server takes as input newly arrived character information from the external information source and the latest configuration set from Step 14. When the server detects that real-time translation is required (for example, for news streams), the server immediately generates a prompt sentence specifically tailored for low-latency processing, such as:

“Translate the following incoming text from English to Japanese in real time. Output concise and accurate Japanese, without commentary: [incoming text].”

Server may segment the incoming text into smaller chunks, calculate token counts for each chunk, and stream each chunk together with the corresponding prompt to the generative AI model in sequence. Server receives partial translations as output and forwards them incrementally to the terminal. The output of this step is a continuous stream of translated segments that can be displayed at the terminal as they are produced, reducing latency and improving responsiveness.

### Step 16:

Terminal displays streaming translation results to the user.

Terminal takes as input incremental translation segments from the server. Terminal appends each new segment to the displayed translation area, optionally marking segments as provisional until the full text has been processed. Terminal maintains scroll position and updates the user interface in real time as new translation tokens arrive. The terminal may also provide indicators showing that the translation is still in progress. The output of this step is an evolving display that allows the user to read the translation almost concurrently with the arrival of the original content, enhancing timeliness and usability.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional translation support systems that rely on machine translation or generative artificial intelligence are typically implemented as straightforward application-level pipelines: text is received from a remote source, passed to a model via a simple request, and the resulting translation is returned to a user device. Such systems generally treat the generative AI model as a black-box component and do not structurally integrate the model's behavior, prompt generation, user state, and data management into a coordinated, computer-technical architecture.

As a result, several technical problems arise in computer systems that provide real-time multilingual information access. First, the interaction between the application server and the generative AI model is often stateless and ad hoc, so that the server does not manage prompt sentences or translation outputs in a manner that is optimized for consistent translation quality, reduced misinformation, or efficient reuse. The server simply forwards raw text to the model, which leads to inconsistent outputs, redundant processing, and increased computational load on networked computing resources.

Second, existing architectures do not adequately control the operational characteristics of the generative AI model itself. Model parameters or control parameters (such as decoding settings, safety constraints, or output validation logic) are usually fixed or manually tuned, which causes a persistent tendency to output hallucinations or misleading translations. From a computer-technical perspective, the server does not include mechanisms to dynamically optimize or adapt these control parameters so as to reduce model-induced misinformation while maintaining throughput and latency requirements in a distributed processing environment.

Third, conventional systems do not structurally integrate user-state-dependent control into the translation pipeline. Even where user emotion or user context is detected at the device level, such information is rarely fed back into the prompt generation and translation adjustment process in a systematic way at the server side. Consequently, the server does not adapt prompts or translation outputs to the detected user state, which leads to a rigid processing flow that fails to leverage available signals for stability, clarity, and appropriateness of the generated translations. This lack of feedback control represents a missed opportunity to improve the behavior of the overall computer system rather than merely altering presentation on the client.

Fourth, in many existing implementations the server does not manage original and translated texts as structured, linked records within a storage subsystem. Original information obtained from external information supply apparatuses and translated information generated by a generative AI model are often handled as transient payloads without stable association, indexing, or retrieval mechanisms. This degrades cache efficiency, complicates synchronization across user devices, and limits the system's ability to serve real-time translations while avoiding unnecessary repeated calls to the generative AI model. It also constrains the server's ability to deliver paired original and translated texts to portable information terminals for simultaneous comparison in a resource-efficient manner.

Accordingly, there is a need for a technical architecture in which a processor cooperatively manages (i) acquisition and structured storage of original text information, (ii) generation and controlled input of prompt sentences to a generative information processing apparatus, (iii) storage and association of translated text information with the original text information, and (iv) adaptive adjustment of prompts and translations based on user emotional state and model control parameters. Such an architecture should improve the behavior of the server as a computing system by reducing misinformation, minimizing redundant translation requests, and enabling portable information terminals to obtain synchronized original and translated texts for concurrent display. The present invention addresses these computer-technical problems by defining specific server-side processing and data flows that integrate generative AI behavior, parameter optimization, and user-state-dependent control into a unified system.

The specific processing by the specific processing unit 290 of the data processing device 12 in Application Example 1 is realized by the following means.

The present invention provides a server comprising a processor and a storage device, the processor being configured to acquire original text information from an external information supply apparatus and store the original text information in the storage device in association with metadata, to generate a prompt sentence including the original text information and input the prompt sentence to a generative information processing apparatus so as to obtain translated text information from a generative information processing model executed by the generative information processing apparatus, to store the translated text information in the storage device in association with the original text information, to transmit the original text information and the translated text information to a portable information terminal in response to an acquisition request from the portable information terminal, to detect an emotional state of a user and adjust at least one of the prompt sentence and the translated text information based on the detected emotional state, and to optimize control parameters of the generative information processing model such that an operational characteristic of the generative information processing model exhibits a reduced tendency to output incorrect information. This enables the server, as a computing system, to manage prompt generation, model interaction, and data association in a structured and adaptive manner, thereby reducing misinformation produced by the generative information processing model, avoiding redundant translation processing, and supplying the portable information terminal with paired original and translated texts that can be displayed simultaneously for real-time comparative viewing while reflecting the user's state in the generated translation outputs.

The term “processor” refers to a hardware or virtual computation unit, such as a central processing unit, a graphics processing unit, or a programmable logic device, that executes instructions to perform logical, arithmetic, control, and input/output operations in the system.

The term “storage device” refers to a hardware or virtual data retention component, such as a main memory, a non-volatile memory, a magnetic storage medium, or a distributed data store, that stores programs, configuration data, original text information, translated text information, and metadata used by the system.

The term “generative information processing apparatus” refers to an information processing arrangement, which may include one or more processors and memories, that executes a generative information processing model to generate output data, such as translated text information, from input data, such as a prompt sentence including original text information.

The term “generative information processing model” refers to a parameterized computational model, such as a neural network or other machine learning model, that generates output information in response to an input sequence, including natural language text, and that can be controlled or configured by control parameters to adjust its output characteristics.

The term “control parameters” refers to configuration values or settings applied to the generative information processing model or its execution environment, including but not limited to decoding parameters, safety thresholds, temperature values, output length limits, or filtering rules, that influence the model's tendency to output information and the properties of such output.

The term “prompt sentence” refers to an input data structure, including at least one natural language expression that may include original text information and one or more instructions, that is provided to the generative information processing apparatus in order to cause the generative information processing model to execute a translation process and generate translated text information.

The term “original text information” refers to textual data in a source language, including one or more sentences, paragraphs, or documents, that is acquired from an external information supply apparatus and used as the subject of a translation process performed by the generative information processing apparatus.

The term “translated text information” refers to textual data in a target language that is generated by the generative information processing model in response to a prompt sentence including original text information, and that is stored in association with the original text information.

The term “external information supply apparatus” refers to an information provision arrangement, including one or more computing devices, that transmits original text information to the server over a communication network, and that is separate from the server and from the portable information terminal.

The term “portable information terminal” refers to a user-operated information processing device having a portable form factor, such as a handheld terminal, a wearable terminal, or a mobile computing device, that communicates with the server over a communication network to acquire and display original text information and translated text information.

The term “metadata” refers to auxiliary data associated with original text information or translated text information, including but not limited to identifiers, timestamps, language attributes, source identifiers, topic attributes, user attributes, or status indicators, that are stored in the storage device to manage retrieval and association.

The term “user” refers to a human operator who interacts with the portable information terminal to request, receive, and view original text information and translated text information provided by the server.

The term “emotional state” refers to information indicative of a user's affective condition, such as stress, confusion, satisfaction, or calmness, which is derived from sensor data, interaction patterns, or explicit user input, and which is used by the server to adjust a prompt sentence and/or translated text information.

The term “adjust” refers to modify, supplement, filter, reformat, or otherwise change at least part of a prompt sentence or translated text information, including altering wording, style, emphasis, or level of detail, in accordance with control logic executed by the processor.

The term “acquisition request” refers to a message transmitted from the portable information terminal to the server over a communication network, the message specifying at least a request for original text information and/or translated text information corresponding to an identifier or other selection condition.

The term “communication network” refers to any wired, wireless, or hybrid data communication infrastructure, including local networks and wide area networks, that enables data exchange among the server, the external information supply apparatus, and the portable information terminal.

The term “operational characteristic” refers to a property of the behavior of the generative information processing model, such as an error rate, a tendency to output hallucinated content, a latency profile, or a stability of translation quality, which is influenced by the control parameters and is subject to optimization in the system.

In one embodiment, a server cooperates with a portable information terminal to provide real-time translation of original text information obtained from an external information supply apparatus, using a generative AI model in a manner that improves computer operation in terms of data management, translation stability, and computational efficiency.

The server uses one or more processors, such as a multi-core central processing unit and optionally one or more graphics processing units, and a storage device such as a relational database system, a document store, or a distributed key-value store. The server executes server-side software, for example an operating system, a web server, an application framework, and a database driver. The server uses a generative AI model implemented as a transformer-based neural network, which is trained to perform sequence-to-sequence translation using large-scale multilingual text corpora. The generative AI model is configured as a parameterized function fθ that maps an input token sequence representing a prompt sentence to an output token sequence representing translated text information.

The server stores original text information and translated text information in a structured data format. The server uses a document-based storage schema in which each article or information unit is represented by a record that includes fields for an original text body, a source language identifier, a target language identifier, metadata such as timestamps and provider identifiers, and one or more nested structures for translated text bodies. The server associates each translated text body with the corresponding original text body via a common record identifier and an explicit language code, thereby enabling direct retrieval of paired original and translated texts without re-translation. This structured storage and association reduce redundant model invocations and lower overall communication and computation loads.

The server generates a prompt sentence for the generative AI model using a deterministic algorithm that combines an instruction segment and a content segment. The server uses a prompt template stored in the storage device, such as:

“Translate the following article into Japanese: [article body]”

or

“Translate the following article into English. Preserve technical terms in their original language and keep paragraph boundaries: [article body]”.

The server replaces the placeholder [article body] with the actual original text information retrieved from the storage device and generates a prompt sentence as a single text string. The server then tokenizes this string using a tokenizer consistent with the generative AI model's vocabulary and sends the resulting token sequence to the model execution environment.

The server configures the generative AI model as a stacked transformer architecture comprising multiple encoder and decoder layers. Each layer includes multi-head self-attention units and feedforward networks, with parameters (weights and biases) stored in model memory. The server sets control parameters for the decoding process, such as temperature, top-k or top-p sampling thresholds, maximum output length, and penalties for repetition. The server updates these control parameters dynamically based on observed output characteristics and user feedback stored in the storage device. For example, when the server detects that a particular configuration yields a high rate of hallucinated content, the server lowers the temperature and tightens the top-k value to bias the model toward more probable sequences, thereby reducing erroneous outputs.

The server optimizes control parameters by maintaining a log of model outputs and associated correctness indicators. The server uses a scoring function that evaluates the consistency of translated text information with the original text information, for example by comparing named entities and numerical values extracted using natural language processing modules. The server calculates error metrics, such as mismatched entity counts or deviation in numerical expressions, and uses these metrics to adjust control parameters in subsequent model calls. By automatically tuning these parameters, the server reduces the model's tendency to produce incorrect translations and improves computational efficiency because fewer re-translations are required.

The server detects an emotional state of a user using signals received from the portable information terminal. The terminal acquires sensor data such as touch interaction patterns, viewing time per segment, voice input characteristics, or biometric indicators supplied by integrated sensors. The terminal transmits processed emotional features, such as a stress index or confusion index, to the server as part of user context data. The server stores this user context data in association with a session identifier and uses a rule-based module or a lightweight classification model to map the emotional features to an emotional state category, for example “confused,” “neutral,” or “confident”.

The server adjusts a prompt sentence and/or translated text information based on the detected emotional state. When the server recognizes that the user is confused, the server modifies the instruction part of the prompt sentence to request simpler language or additional explanatory content, for example:

“Translate the following article into Japanese using simple expressions and add brief clarifications for specialized terms: [article body]”.

When the server recognizes that the user is confident, the server may instruct the generative AI model to preserve technical terminology more strictly, for example:

“Translate the following article into English and keep all technical terms unchanged: [article body]”.

The server thus uses user-state-dependent rules to shape the generative AI model's behavior, which is not merely automating human translation work but structurally changing how the computing system generates and manages translations.

The server utilizes a training process for the generative AI model that includes minimizing a sequence-to-sequence loss function, such as cross-entropy between predicted token distributions and ground-truth translations. During training, the server or a training platform performs weight updates using gradient-based optimization (for example, stochastic gradient descent with adaptive learning rate methods). The training process incorporates regularization techniques and data augmentation, such as random masking of tokens and sentence reordering, to improve robustness. As a result, the deployed model achieves stable performance under varying prompt formulations, and the server can exploit this stability when adjusting prompts to accommodate different emotional states without significantly degrading accuracy.

The server performs feature extraction from original text information to assist in controlling the generative AI model. The server extracts entities, numerical expressions, and structural markers (e.g., headings and paragraph breaks) using dedicated natural language processing components. The server includes this structural information in the prompt sentence, for example:

“Translate the following article into Japanese. Preserve all headings marked with [HEADER] and maintain the numbering of sections: [article body with markup]”.

Because the server explicitly encodes these features in the prompt sentence, the generative AI model is more likely to produce outputs that preserve document structure. This leads to reduced post-processing and fewer corrections on the terminal side, thereby improving the overall throughput of the system.

The server manages communication with the generative AI model execution environment over a network connection. The server aggregates multiple prompt sentences into batched requests when several articles or segments require translation simultaneously. The server constructs a batch data structure containing multiple token sequences and sends them in a single operation to the model execution environment. By doing so, the server reduces the overhead associated with network round trips and improves resource utilization on the model execution infrastructure. The server stores batch identifiers and decomposes the returned batch of translated text information into individual records, which are then associated with their respective original text information in the storage device.

The terminal operates as a portable information terminal such as a smartphone or a wearable terminal running a client application. The terminal maintains a local cache of original text information and translated text information using a structured local data store. The terminal stores entries keyed by article identifiers and language codes and includes metadata such as last access time and version numbers. The terminal requests only updates for entries whose version numbers held in the local cache are older than those in the server's storage device.

This differential update mechanism reduces communication load between the server and the terminal and speeds up retrieval of content for repeated viewing.

The terminal presents paired original and translated texts in a synchronized viewing interface.

The terminal implements a dual-pane or split-screen layout in which one pane displays the original text and the other pane displays the translated text. The terminal maintains a mapping between segment identifiers (for example, paragraph indices) in the original text and corresponding segments in the translated text. The terminal adjusts scroll positions of both panes according to this mapping, such that when the user scrolls the original text, the corresponding portion of the translated text is brought into view. This synchronized display is enabled by the server's consistent segmentation and storage of original and translated texts using aligned segment identifiers.

The user interacts with the terminal to select an article, choose a target language, or request a change in translation style. The user may, for example, select a button labeled “Simplify Translation” or “Show More Detail”. The terminal transmits this selection to the server as a change in user preference, and the server updates prompt generation rules or style parameters accordingly. This interaction causes the server to reformulate prompt sentences, potentially triggering a re-translation with modified instructions. Because the server maintains the original text information and its associated translations in a structured data model, the server can efficiently generate additional translations or alternative versions and link them to the same original record.

The server provides multiple alternative implementations for the generative AI model. In one variant, the server uses a transformer-based encoder-decoder model. In another variant, the server uses a decoder-only autoregressive model that conditions on the prompt sentence and generates the translated sequence token by token. In another variant, the server employs an ensemble of models and selects among outputs based on a scoring function that considers consistency with extracted features of the original text. In all variants, the server manages control parameters and prompt formulations in a systematic way, using stored configuration profiles and measured performance indicators.

The server differentiates its processing from conventional human translation workflows by applying explicit computational rules that are not feasible for manual operation at scale. For example, the server enforces a rule that all numerical sequences appearing in the original text must be preserved unchanged in the translated text. The server implements this rule by pre-processing the original text to mark numerical sequences with a special token and by checking translated outputs to confirm that the same numerical sequences appear. If a discrepancy is detected, the server either corrects the translated text automatically or triggers a re-translation with a refined prompt sentence emphasizing numerical preservation, such as:

“Translate the following article into Japanese and keep all numbers exactly as in the original: [article body]”.

This combination of pre-processing, model control, and post-verification constitutes a non-conventional computational process that directly improves translation accuracy and reduces error rates.

The server also applies non-standard evaluation procedures to the generative AI model's outputs. The server uses a similarity metric between the original and translated texts, such as alignment of named entities or semantic similarity scores derived from a separate embedding model. When the server detects that a translation falls below a certain similarity threshold, the server dynamically increases constraints in the control parameters, such as lowering temperature or disabling sampling in favor of greedy decoding. This adaptive decoding strategy reduces the chance of hallucinated content and stabilizes system performance, which improves the reliability of the computer system itself.

The terminal can be implemented in alternative hardware forms, including smartphones, tablets, head-mounted displays, and other mobile computing platforms. In one variant, the terminal uses a head-mounted display to overlay translated text information in the user's field of view while preserving the original text displayed on another device. The terminal receives aligned segments from the server and superimposes translations near the corresponding regions, enabling real-time augmented reality translation. The server supports this use case by providing text segmentation and positional metadata, which are stored and transmitted as part of the record structure.

The system thus improves computer technology by introducing a structured, feedback-controlled interaction between the server, the generative AI model, and the portable information terminal. The server's management of prompt sentences, dynamic optimization of model control parameters, structured association of original and translated texts, and user-state-based adjustments collectively produce lower error rates, reduced redundant computations, more efficient network usage, and improved responsiveness compared to conventional architectures that treat translation as a simple stateless API call.

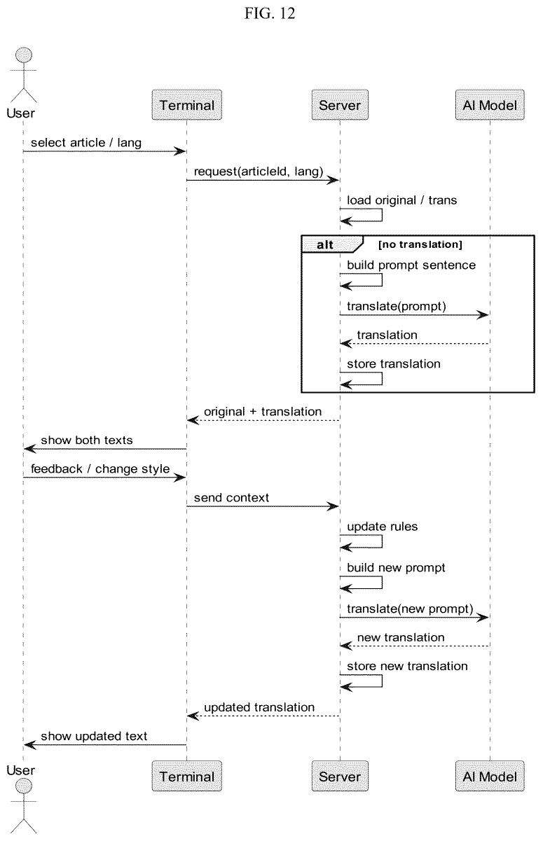

The following describes the processing flow using FIG. 12.

### Step 1:

The server receives original text information from an external information supply apparatus via a network. The input to the server is a message containing at least an article identifier, a source language code, and an article body in the source language. The server performs data validation, such as checking that required fields are present and that the article body length is within predetermined limits, and converts the received message into an internal data structure (for example, a record or document). The output of this step is a validated internal representation of the original text information ready for storage.

### Step 2:

The server stores the validated original text information in a storage device in association with metadata. The input to the server is the internal representation of the article generated in Step 1. The server generates a unique record identifier, attaches metadata such as a timestamp, a provider identifier, and a source language code, and writes these fields into a structured record in the storage device. The server may also segment the article body into paragraphs or sentences and assign segment indices. The output of this step is a stored record that associates the article identifier, the segmented original text information, and the metadata.

### Step 3:

The server determines whether translation is required and selects a target language. The input to the server is the stored record containing the source language code and possibly user or system language settings. The server compares the source language code with one or more configured target language codes and applies a rule set, such as “translate all non-local languages into a predefined local language.” The server may also consult user preference records stored in the storage device. The output of this step is a decision structure indicating whether translation is needed and specifying one or more target languages.

### Step 4:

The server generates a prompt sentence for a generative AI model based on the original text information and the selected target language. The input to the server is the stored original text (optionally segmented), the target language, and a prompt template. The server inserts the original text into a prompt template and forms a complete prompt sentence such as “Translate the following article into Japanese: [article body]” or “Translate the following article into English and preserve all technical terms: [article body]”. The server may also append structural markers (for headings, lists, or numerical expressions) into the text. The output of this step is a fully constructed prompt sentence string to be provided to the generative AI model.

### Step 5:

The server tokenizes the prompt sentence and prepares a request to the generative AI model. The input to the server is the prompt sentence string generated in Step 4 and the model configuration (e.g., model name, maximum token length, temperature, top-k or top-p values). The server uses a tokenizer compatible with the generative AI model to convert the prompt sentence into a sequence of tokens (numerical IDs). The server creates a request payload that includes the token sequence and control parameters. The output of this step is a formatted model request suitable for submission to the generative AI model execution environment.

### Step 6:

The server sends the model request to the generative AI model execution environment and obtains translated text tokens. The input to the server is the formatted request from Step 5.

The server transmits the request over a network interface to a model hosting service or a dedicated model server and waits for a response. The generative AI model, which is implemented as a transformer-based neural network, processes the input tokens to generate output tokens representing the translated text. The server receives the model's response containing the sequence of output tokens and metadata, such as token counts and processing time. The output of this step is the raw translated token sequence and associated metadata.

### Step 7:

The server decodes the translated token sequence into translated text information and performs post-processing. The input to the server is the output token sequence and metadata received in Step 6. The server applies a decoder (inverse tokenizer) to map tokens back to text characters and strings. The server then applies post-processing operations, such as trimming whitespace, normalizing punctuation, checking that marked numerical strings match the original, and verifying that required structural markers appear correctly. If discrepancies are detected (e.g., missing numbers or overridden markers), the server may apply correction rules or flag the translation for re-processing. The output of this step is a cleaned, human-readable translated text string for the target language.

### Step 8:

The server stores the translated text information in association with the corresponding original text information. The input to the server is the translated text string from Step 7 and the record identifier of the original article. The server updates the existing record in the storage device or creates a related record in a translation sub-collection, writing fields such as the translated text body, the target language code, and a translation timestamp. The server preserves segment indices if the text was segmented, linking each translated segment ID to the corresponding original segment ID. The output of this step is an updated storage record that associates original and translated texts, enabling efficient retrieval by identifier and language.

### Step 9:

The server monitors translation quality and updates control parameters for the generative AI model. The input to the server is a set of pairs of original and translated texts (possibly across multiple articles) and quality indicators such as mismatch rates of entities, numbers, or alignment scores computed by additional analysis modules. The server computes error metrics for each pair and aggregates them over a time window. Based on these metrics, the server adjusts control parameters (for example, lowering temperature or changing sampling strategy) and updates stored configuration profiles for future translation calls. The output of this step is a revised set of control parameters designed to reduce erroneous outputs in subsequent model invocations.

### Step 10:

The terminal sends an acquisition request to the server to retrieve original and translated texts. The input to the terminal is user interaction, such as a tap on an article entry or a selection of a language option. The terminal constructs a request message that includes an article identifier, a desired target language, and optionally a version number or timestamp of any locally cached copy. The terminal transmits this message to the server over a communication network. The output of this step is a network request addressed to the server that specifies which data should be retrieved.

### Step 11:

The server receives the acquisition request from the terminal and retrieves the corresponding records from the storage device. The input to the server is the request message containing the article identifier and target language. The server queries the storage device for a record matching the identifier and fetches both the original text information and the translated text information for the requested target language. If a translation record is not found, the server may trigger Steps 4 through 8 to generate a new translation. The output of this step is a data structure containing the original text, the translated text, metadata, and segment alignment information if available.

### Step 12:

The server formats the retrieved data for transmission to the terminal. The input to the server is the record obtained in Step 11. The server selects relevant fields (such as title, original text segments, translated text segments, and language codes) and organizes them into a response structure that associates each original segment ID with a corresponding translated segment ID. The server may compress the data if needed and then encapsulate the structure in a response message. The output of this step is a serialized data payload ready to be sent to the terminal.

### Step 13:

The terminal receives the response from the server and stores or updates local cached entries.

The input to the terminal is the response payload transmitted by the server. The terminal parses the payload, extracts the original and translated texts, article identifiers, and version information, and writes them into a local data store keyed by identifier and language. The terminal may also remove stale entries or update their metadata (such as last accessed time).

The output of this step is an updated local cache that holds synchronized original and translated texts for offline or repeated viewing.

### Step 14:

The terminal generates a synchronized display layout for the original and translated texts. The input to the terminal is the original and translated text segments with alignment information from Step 13. The terminal creates user interface components for two display panes (or a single pane with toggling capability) and assigns each original segment and corresponding translated segment to aligned positions in these panes. The terminal computes scroll offsets or anchor positions so that corresponding segments can be aligned when scrolled. The output of this step is a fully configured display layout ready for rendering on the device screen.

### Step 15:

The terminal renders the original and translated texts and manages synchronized scrolling.

The input to the terminal is the configured layout from Step 14 and user interaction events, such as scroll gestures. The terminal draws the original text in one pane and the translated text in another pane, using fonts and layout parameters suited to the device form factor. When the user scrolls one pane, the terminal calculates the corresponding segment index and adjusts the other pane's scroll position to bring the aligned translated or original segment into view.

The output of this step is a synchronized, side-by-side or stacked display that allows the user to compare the original and translated texts in real time.

### Step 16:

The user views the displayed texts and may provide explicit feedback or change preferences.

The input to the user is the visual presentation of the original and translated texts rendered by the terminal. The user may, for example, press a button to request a simpler translation, select a different target language, or mark a passage as confusing. The user interaction results in specific commands or feedback signals that the terminal captures as structured data. The output of this step is user-generated preference or feedback data.

### Step 17:

The terminal transmits user preference and emotional-state-related information to the server.

The input to the terminal is the feedback or selection data from Step 16, as well as sensor-derived indicators such as reading time per segment or interaction patterns. The terminal assembles these inputs into a context message containing user identifiers, feedback flags, and numerical indices representing emotional or cognitive state. The terminal sends this message to the server. The output of this step is a structured user context request delivered to the server.

### Step 18:

The server updates user context records and adjusts future prompt generation based on the received information. The input to the server is the user context message from Step 17. The server writes user preferences and emotional indices into context records associated with the user or session. The server applies rules that map this context to prompt styles, such as selecting between a “simplified explanation” template and a “technical detail” template. The server thus modifies the parameters of the prompt generation algorithm used in Step 4. The output of this step is an updated set of prompt generation rules and style parameters that will influence subsequent translations for that user.

### Step 19:

The server, in response to updated prompt rules, generates a new prompt sentence and obtains an updated translation when necessary. The input to the server is an existing original text record and the revised prompt style parameters from Step 18. The server constructs a new prompt sentence, for example, “Translate the following article into Japanese using simple expressions and add short explanations for specialized terms: [article body]”, and then repeats Steps 5 through 8 to obtain and store a new translated text that reflects the user's state and preferences. The output of this step is an alternative translated text version associated with the same original text, which the terminal can retrieve and display to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In machine translation systems using a generative AI model, several technical problems arise at the level of computer system performance and reliability.

First, when raw user input is directly supplied to a generative AI model, the absence of systematic preprocessing causes inefficient use of processing resources and unstable output behavior. For example, inconsistent character encoding, redundant whitespace, and noise characters increase the length and complexity of the input sequence, leading to increased memory consumption, longer inference time, and a higher probability of generation errors by the model.

Second, if the instruction to the generative AI model is not explicitly structured as a prompt sentence that accurately reflects translation direction, field, and style, internal computation in the model may be misaligned with the user's intended task. This mismatch results in degraded translation quality and forces repeated user interaction, thereby increasing overall system load and latency.

Third, conventional systems generally treat translation as a one-shot inference without integrating user feedback into the operational loop of the system. In such configurations, evaluation information or correction information from users is not systematically captured or exploited by the server. As a result, the server cannot adapt internal parameters, generation conditions, or prompt design, and cannot reduce misinformation occurrence rates over time.

From a computer-technology perspective, the system lacks a feedback-driven optimization mechanism that improves the behavior of the model and the surrounding processing pipeline.

Fourth, in many existing architectures, translation generation is performed in a batch manner and the translated result is returned only after the entire output is produced. This causes high perceived latency for the user and prevents the server from using incremental processing and streaming transmission. In particular, the server does not efficiently orchestrate preprocessing, prompt construction, model invocation, and network transmission as a pipeline, thereby failing to reduce end-to-end response time or to improve the utilization of processing resources in real-time scenarios.

Accordingly, there is a need for a computer-implemented translation system that improves the technical performance of the underlying computing environment by: (i) enforcing structured preprocessing and postprocessing around a generative AI model, (ii) generating task-specific prompt sentences that encode translation conditions as machine-interpretable control information, (iii) capturing and reusing user feedback as learning information to optimize model-related parameters and prompt-generation logic, and (iv) enabling real-time, stepwise generation and transmission of translation results to reduce latency and enhance throughput.

The specific processing by the specific processing unit 290 of the data processing device 12 in Example 2 is realized by the following means.

The present invention provides a server comprising a processor configured to obtain, from an external terminal, request information including character information to be translated and translation condition information, perform preprocessing on the character information to be translated by executing normalization processing and unnecessary-character removal processing, generate, based on the preprocessed character information to be translated and the translation condition information, a prompt sentence for translation instruction in accordance with translation direction information and field information, construct input information for a generative AI model by combining the prompt sentence with the preprocessed character information to be translated, execute encoding processing to convert the input information into a code sequence, invoke the generative AI model using the code sequence to generate a translation character string by numerical computation processing, perform postprocessing on the translation character string obtained from the generative AI model, the postprocessing including format-unification processing and grammar-checking processing, transmit postprocessed translation result information to the external terminal, obtain, from the external terminal, evaluation information or correction information regarding the translation result information, store the evaluation information or the correction information in a storage device, and use the evaluation information or the correction information as learning information to update processing for generating the prompt sentence or operating conditions of the generative AI model. This enables improvement of the operation of the computer-based translation system itself, by reducing unnecessary computational load through structured preprocessing, enhancing the stability and accuracy of generative AI inference via explicitly controlled prompt sentences, adaptively optimizing model parameters and generation conditions using feedback-driven learning within the server, and decreasing end-to-end response time by permitting efficient, real-time orchestration of preprocessing, model invocation, and transmission of translation results.

The term “processor” refers to a hardware-based or virtual computation unit, including a central processing unit, graphics processing unit, or logic circuitry, that executes program instructions to perform data processing operations.

The term “external terminal” refers to an information processing apparatus, such as a client device or user-operated device, that communicates with the server over a communication network to send request information and receive translation result information.

The term “request information” refers to information transmitted from the external terminal to the server and including at least character information to be translated and translation condition information used to control translation processing.

The term “character information to be translated” refers to textual data, represented as a sequence of characters or symbols, that is designated as a source text for translation by the system.

The term “translation condition information” refers to control information specifying conditions for translation processing, including at least translation direction information and optionally field information, style information, or domain information.

The term “normalization processing” refers to processing that converts the character information to be translated into a canonical form, including at least unifying character encoding, standardizing character variants, and harmonizing whitespace or line break representations.

The term “unnecessary-character removal processing” refers to processing that detects and removes characters that are not required for translation, including at least redundant whitespace, control characters, or noise characters that do not contribute to semantic content.

The term “prompt sentence” refers to a text string that explicitly instructs a generative AI model to perform a translation task under specified conditions, and that is constructed to encode translation direction and other translation condition information in a machine-interpretable format.

The term “translation direction information” refers to information indicating a source language and a target language for translation, or indicating a direction of conversion between at least two languages or language variants.

The term “field information” refers to information specifying a technical or contextual field for translation, including but not limited to general, business, legal, medical, or technical domains.

The term “input information for a generative AI model” refers to structured data provided to the generative AI model, the structured data including at least a prompt sentence and the preprocessed character information to be translated, and optionally including translation condition information or generation parameters.

The term “generative AI model” refers to a machine-learned model, typically implemented as a neural network, that performs sequence generation or text generation by executing numerical computation on input information to output a translation character string.

The term “encoding processing” refers to processing that converts input information, including the prompt sentence and the preprocessed character information to be translated, into a code sequence such as a sequence of tokens or numerical identifiers suitable for input to the generative AI model.

The term “code sequence” refers to a sequence of codes, including tokens, token identifiers, or numerical indices, representing the encoded form of the input information as accepted by the generative AI model.

The term “numerical computation processing” refers to arithmetic operations, including at least matrix operations, activation functions, and probability computations, executed by the generative AI model on the code sequence to generate output data.

The term “translation character string” refers to a sequence of characters representing the result of translation generated by the generative AI model in a target language specified by the translation direction information.

The term “postprocessing” refers to processing performed on the translation character string to obtain translation result information, the processing including at least format-unification processing and grammar-checking processing to improve readability and correctness.

The term “format-unification processing” refers to processing that adjusts textual layout or notation style of the translation character string, including normalization of punctuation, spacing, and quotation formats according to target-language conventions.

The term “grammar-checking processing” refers to processing that analyzes the translation character string to detect and correct grammatical, syntactic, or orthographic errors.

The term “translation result information” refers to information representing the final translation output after postprocessing, including at least a postprocessed translation character string intended for presentation to a user.

The term “evaluation information” refers to information indicating an assessment of translation quality provided by a user, including at least ratings, labels, or qualitative feedback regarding the translation result information.

The term “correction information” refers to information indicating one or more corrections or alternative expressions to the translation result information, provided by a user through the external terminal.

The term “storage device” refers to a memory apparatus, including at least non-volatile storage or database storage, that stores data such as evaluation information, correction information, and parameters related to prompt generation or model operation.

The term “learning information” refers to information, including evaluation information or correction information, that is used to update or optimize prompt generation processing or operating conditions of the generative AI model.

The term “operating conditions of the generative AI model” refers to parameters controlling execution of the generative AI model, including at least generation-condition parameters such as temperature, maximum length, decoding strategy, and related configuration values.

The term “output characteristics of the generative AI model” refers to statistical or qualitative properties of output data generated by the generative AI model, including at least accuracy, fluency, consistency with conditions, and misinformation occurrence rate.

The term “generation-condition parameters” refers to adjustable parameters governing the generation behavior of the generative AI model, including at least temperature, top-k or top-p sampling thresholds, beam width, and maximum output token count.

The term “misinformation occurrence rate” refers to a measure indicating a frequency or probability with which the generative AI model outputs incorrect, misleading, or hallucinated information in translation results.

The term “sequentially provide the input information” refers to an operation in which portions of input information are generated and supplied to the generative AI model in a stepwise or streaming manner, instead of as a single batch, in response to receipt of request information.

The term “real time” refers to processing in which at least part of the translation character string is generated and transmitted with latency low enough that a user can perceive the output as being produced substantially concurrently with or shortly after providing the input.

The term “stepwise manner” refers to a transmission mode in which partial translation results or segments of the translation character string are sent from the server to the external terminal in multiple stages rather than as a single final message.

In one embodiment, a server cooperates with a terminal used by a user to provide a translation service based on a generative AI model. The server includes at least one processor, a main memory, a storage device, and a communication interface. The terminal is implemented as an information processing apparatus such as a personal computer, a smartphone, or a tablet device including a display unit, an input unit, a processor, a memory, and a communication module.

The server executes a translation control program stored in the storage device and loaded into the main memory. The translation control program is implemented using a software stack such as an operating system, an HTTP server, and an application framework. For example, the server uses a general-purpose operating system, a web server process, and an application framework such as a scripting language runtime with a web framework. The server further uses a machine learning library such as a tensor computation library or a deep learning framework to execute the generative AI model on a hardware accelerator such as a graphics processing unit.

The server functions as an information processing apparatus that receives request information from the terminal, processes the request information, and returns translation result information. The terminal functions as a client apparatus that presents a user interface to the user, transmits the request information to the server, and displays the translation result information received from the server. The user operates the terminal to input source text to be translated and to specify translation conditions such as source language, target language, and translation field.

The server stores a generative AI model in the storage device. In one embodiment, the generative AI model is implemented as a transformer-based neural network comprising an embedding layer, a plurality of encoder layers, and a plurality of decoder layers. Each encoder layer and each decoder layer includes multi-head self-attention sub-layers, feed-forward sub-layers, and normalization sub-layers. The generative AI model is trained as a sequence-to-sequence model using a large number of parallel sentence pairs in different languages. The server loads the generative AI model into the main memory and executes the model on the processor and, optionally, on a graphics processing unit.

The server is configured to perform preprocessing on character information to be translated before supplying the character information to the generative AI model. The server stores program modules that perform normalization processing and unnecessary-character removal processing. For example, the server uses a character processing library to unify Unicode normalization forms, unify character encodings to a common encoding format, and convert variant forms of characters into corresponding canonical forms. The server further executes routines that scan the character sequence to identify and remove redundant whitespace, control characters, and non-printable characters. These routines operate on string data structures in memory and generate a preprocessed string with reduced noise and reduced length.

The server is configured to generate a prompt sentence for translation instruction based on the preprocessed character information and translation condition information. The server stores template data in the storage device. The template data includes textual patterns that specify translation direction and field. For example, the server stores a pattern such as:

“Translate the following English sentence to Japanese: ‘<TEXT>’”

The server replaces the placeholder <TEXT> with the preprocessed character information to be translated. As another example, the server uses a pattern such as:

“Translate the following Japanese business email into polite and natural English: ‘<TEXT>’”

The server selects an appropriate template based on translation condition information such as source language, target language, and field information. The server then concatenates the selected template with the preprocessed character information to construct a prompt sentence that explicitly instructs the generative AI model to perform a specific translation task. The server stores the generated prompt sentence in memory as a character string object.

The server constructs input information for the generative AI model by combining the prompt sentence and the preprocessed character information. In one embodiment, the server uses a tokenizer module associated with the generative AI model. The tokenizer converts the prompt sentence, including the embedded preprocessed character information, into a sequence of token identifiers. The server provides the token identifiers as the input sequence to the generative AI model. The server optionally provides additional control tokens or special tokens representing translation direction or field information. Thus, the server encodes both natural language instruction and translation conditions into a machine-readable code sequence.

The server executes encoding processing by invoking the tokenizer to convert the input information into a sequence of integer values. The tokenizer decomposes the character sequence into subword units using a predefined subword segmentation algorithm such as byte pair encoding or an alternative segmentation algorithm. The tokenizer maps each segment to an index in a vocabulary table stored in the storage device. By performing this encoding, the server reduces the variable-length character string into a fixed-format numerical representation suited to the internal architecture of the generative AI model. This improves calculation efficiency and reduces memory fragmentation during model execution.

The server invokes the generative AI model by supplying the encoded code sequence to the model. The server controls the model execution by specifying generation-condition parameters such as maximum output length, temperature, and beam width. The server uses the machine learning library to compute the forward pass of the model. Specifically, the server executes numerical computation including matrix multiplications, vector additions, non-linear activation functions, attention weight computation, and softmax operations. These computations are performed on the processor and, optionally, on a graphics processing unit.

In one embodiment, the server executes beam search decoding or another advanced decoding strategy to generate a translation character string that maximizes a likelihood measure under the model.

The server generates the translation character string token by token. At each decoding step, the generative AI model outputs a probability distribution over the vocabulary. The server selects one or more candidate tokens according to the decoding strategy and appends them to the output sequence. The server repeats this iterative process until an end-of-sequence condition is satisfied or the maximum output length is reached. The server then decodes the output token identifiers back into a character string using the tokenizer, thereby obtaining a raw translation character string in the target language.

The server is configured to perform postprocessing on the translation character string. The server executes format-unification processing by adjusting punctuation, spacing, and text layout according to the target language conventions. The server uses text processing routines to normalize quotation marks, remove duplicated punctuation, and unify line break representations. The server further performs grammar-checking processing by applying rule-based analysis or external grammar modules to detect syntactic anomalies and spelling errors.

These postprocessing operations modify the translation character string in memory and yield translation result information that is more readable and consistent.

The server transmits the postprocessed translation result information to the terminal through the communication interface. The translation result information is transmitted as a response message over a communication network. The terminal receives the translation result information, decodes the message content, and displays the translated text in a display area.

The user can visually confirm the translation and, if desired, provide evaluation information or correction information through the user interface.

The server is configured to collect and store evaluation information and correction information obtained from the terminal. The server stores this feedback in the storage device as learning information. The server analyzes the feedback using data processing routines that aggregate statistics on errors, user corrections, and satisfaction levels. For example, the server calculates the frequency of specific error types, the proportion of outputs judged as incorrect, and the association between error patterns and particular prompt sentence templates or generation-condition parameters.

The server uses the learning information to update the prompt generation logic and operating conditions of the generative AI model. In one embodiment, the server adjusts template selection rules based on fields where errors frequently occur. For instance, if feedback indicates frequent errors in a technical domain, the server modifies the corresponding template to include additional instructions such as:

“Translate the following Japanese technical description into clear and accurate English for software engineers: ‘<TEXT>’”

The server also updates generation-condition parameters such as temperature and beam width to reduce the occurrence of hallucinated or misleading content. The server thereby implements a feedback-driven optimization mechanism that directly modifies internal operation of the translation control program and the behavior of the generative AI model.

In another embodiment, the server performs fine-tuning of the generative AI model using a subset of sentences for which correction information is available. The server constructs training pairs consisting of the original input information (prompt sentence and preprocessed character information) and the corrected translation text. The server executes a training procedure in which the model parameters are updated to minimize a loss function such as cross-entropy between the model output and the corrected target text. The server uses gradient-based optimization and adjusts model weights stored in the storage device. By repeating this process on new feedback data, the server improves the internal mapping performed by the generative AI model, thereby reducing misinformation occurrence rate in subsequent inferences.

The described configuration improves computer technology in multiple respects. The server reduces computational load and memory consumption by applying structural preprocessing that shortens input sequences and eliminates noise before model execution. This preprocessing directly affects the number of tokens processed by the generative AI model, resulting in faster inference time and lower energy consumption on the processor and graphics processing unit. The server further improves translation accuracy and stability by generating prompt sentences that explicitly encode translation conditions in a consistent machine-readable format. This structured prompting reduces ambiguity in the model's internal computation and decreases the probability that the model performs an unintended task.

Moreover, the server integrates user feedback into a closed-loop control mechanism that tunes both high-level prompt design and low-level generation-condition parameters. This mechanism is not a mere automation of human judgment; instead, it modifies internal numeric thresholds, parameter vectors, and rule sets that control resource allocation and search behavior during decoding. As a result, the system reduces misinformation occurrence rate and adjusts its computational strategy based on observed error patterns. This leads to more efficient use of computing resources and improved quality of service over time.

The server also supports real-time and stepwise generation of translation results. In one variant, the server begins decoding as soon as a sufficient prefix of the prompt sentence and the preprocessed character information is encoded. The server then streams partial translation segments to the terminal as they are produced. By overlapping encoding, model execution, and network transmission, the server constructs a processing pipeline that significantly reduces perceived latency for the user. This pipeline approach improves throughput and responsiveness of the system compared to batch-only architectures.

The server applies non-conventional rules and procedures that differ from manual human translation workflows. For example, the server defines specific criteria for truncating input sequences based on token budgets, defines attention-masking patterns in the generative AI model to segregate instruction tokens from content tokens, and defines specialized penalties in decoding to avoid repetition and to enforce coverage of source segments. These procedures are applied programmatically within the machine learning library and depend on internal state vectors computed by the generative AI model, which are not directly available to human translators.

The internal learning process of the generative AI model is also concretely defined. The server maintains a training pipeline that uses mini-batches of encoded input and output sequences, computes a loss function such as token-level cross-entropy, and performs backpropagation to calculate gradients with respect to model parameters. The server updates the parameters using optimization algorithms such as stochastic gradient descent or adaptive gradient methods. The server may also apply data augmentation techniques such as synonym replacement, noise injection, or back-translation to increase robustness of the model and reduce overfitting. These training operations are executed on numerical arrays stored in memory and involve repeated matrix operations and vector updates.

In another embodiment, the server uses variant generative AI models. For example, the server may use a decoder-only autoregressive model that receives the prompt sentence and source text concatenated as a single sequence. In such a case, the server configures the tokenizer and attention masks so that the model can distinguish instruction tokens from source text tokens and generate target language tokens at the end of the sequence. The server may also use an encoder-decoder architecture or a multilingual model that supports multiple language pairs with a single parameter set. The server can select between these models dynamically based on translation condition information, thereby balancing speed and accuracy.

The server may be implemented on a single physical machine or on a distributed system comprising multiple machines. In a distributed configuration, one machine may act as a front-end server receiving requests and performing preprocessing, while another machine equipped with a high-performance graphics processing unit executes the generative AI model. The machines communicate over a local network using an internal protocol. This modular architecture allows scaling of model inference capacity independently of front-end request handling and contributes to improved overall system performance.

The terminal can be implemented as a web browser application or as a native application. The terminal provides user interface components such as text input boxes, language selection widgets, and feedback forms. The terminal sends structured request information to the server and receives structured translation result information in response. The terminal is not required to execute the generative AI model; instead, it depends on the server for heavy computation, which allows lightweight devices with limited resources to benefit from advanced translation capabilities.

The user interacts with the system by entering text to be translated and by optionally reviewing and adjusting translation results. The user can provide explicit evaluation information, such as a rating or comment, and can enter corrections directly in the interface. The terminal transmits this information back to the server. The server processes this information in a standardized internal format and uses it to drive the feedback-based optimization processes described above.

By combining these elements, the system provides a concrete implementation that allows another person skilled in the art to realize the invention. The server, terminal, and user cooperate in a way that leverages specific data structures, specific model architectures, and specific processing steps to improve computational efficiency, translation accuracy, and responsiveness of a computer-based translation environment using a generative AI model and prompt sentences.

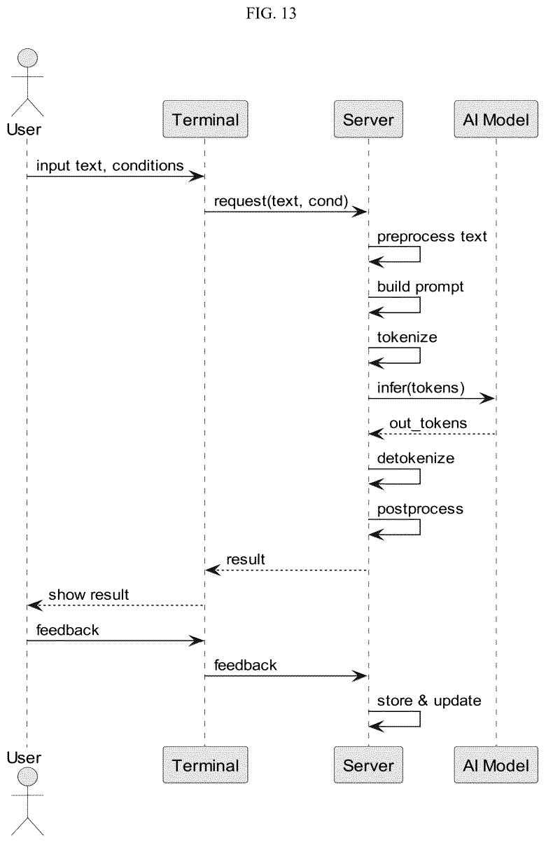

The following describes the processing flow using FIG. 13.

### Step 1:

The user operates the terminal to input character information to be translated.

The terminal displays an input area on a screen and receives keystrokes or pasted text from the user as input.

The terminal additionally receives translation condition information from the user, such as a selected source language, a selected target language, and an optional field (for example, general, business, or technical).

The terminal generates request information as output, the request information including at least the character information to be translated and the translation condition information in a structured internal format.

### Step 2:

The terminal sends the request information to the server.

The terminal uses a communication module to encapsulate the request information into a message, for example an HTTP request, and transmits the message over a communication network.

The terminal may add metadata such as a request identifier and a timestamp.

The terminal outputs a network packet containing the request information, and the server receives this packet as input at a communication interface.

### Step 3:

The server receives and parses the request information from the terminal.

The server reads the network packet via its communication interface and passes the packet payload to an application program as input.

The server decodes the message format (for example, parses a structured text format) to extract the character information to be translated and the translation condition information.

The server outputs separated internal variables representing the source text, the source language, the target language, and the field information, which are used as input to subsequent processing.

### Step 4:

The server performs preprocessing on the character information to be translated.

The server uses a text-processing module to apply normalization processing to the input character string, including unifying character encoding and converting characters to a canonical form.

The server further performs unnecessary-character removal processing by scanning the normalized string to detect redundant whitespace, control characters, and noise symbols, and removes them from the string.

Based on the input raw character string, the server performs string rewriting and filtering operations to obtain a cleaned and normalized character string.

The server outputs the preprocessed character string as input for prompt sentence generation.

### Step 5:

The server generates a prompt sentence based on the preprocessed character string and the translation condition information.

The server selects a template pattern using the source language, target language, and field information as input.

For example, when the input conditions indicate English-to-Japanese and a general field, the server selects a template such as:

“Translate the following English sentence to Japanese: ‘<TEXT>’”

The server then replaces the placeholder <TEXT> with the preprocessed character string by concatenating the template segments and the cleaned source text.

As another example, when the conditions indicate Japanese-to-English and a business field, the server may generate:

“Translate the following Japanese business email into polite and natural English: ‘<TEXT>’”

The server outputs the constructed prompt sentence as a character string, which serves as input to the encoding processing.

### Step 6:

The server constructs input information for the generative AI model.

The server combines the prompt sentence and, if necessary, additional control markers or special tokens representing translation direction or field information.

The server forms a single composite text sequence from the prompt sentence and the embedded preprocessed character string, and assigns this composite text sequence as input data to a tokenizer.

The server outputs a composite text sequence as input for tokenization.

### Step 7:

The server performs encoding processing to convert the composite text sequence into a code sequence.

The server uses a tokenizer associated with the generative AI model and receives the composite text sequence as input.

The server applies a segmentation algorithm, such as a subword-based algorithm, to divide the composite text into subword units, and maps each subword unit to a numerical identifier using a vocabulary table stored in memory.

By iterating through the entire composite text sequence, the server creates an array of token identifiers and an optional attention mask indicating valid positions.

The server outputs the token identifier sequence and the attention mask as input to the generative AI model.

### Step 8:

The server invokes the generative AI model and generates a translation character string.

The server passes the token identifier sequence and the attention mask to the generative AI model as input data.

The server configures generation-condition parameters such as maximum output length, temperature, and beam width based on the translation condition information and system settings.

The generative AI model, executed by the server's processor and optionally by a graphics processing unit, performs numerical computations on the input token identifiers.

The server causes the model to perform matrix multiplications, attention weight calculations, activation functions, and softmax operations over the vocabulary, and iteratively decodes output tokens according to the specified decoding strategy (for example, greedy search or beam search).

The server collects the generated output token identifiers step by step until an end-of-sequence condition or maximum length is reached.

The server outputs a sequence of output token identifiers as input to a decoding module.

### Step 9:

The server decodes the output token identifiers into a translation character string.

The server uses the tokenizer in reverse mode and receives the output token identifier sequence as input.

The server maps each identifier back to its corresponding subword string and concatenates the subword strings in sequence to reconstruct a character string in the target language, skipping special control tokens.

The server obtains a raw translation character string, which may include extraneous spaces or punctuation artifacts.

The server outputs this raw translation character string as input for postprocessing.

### Step 10:

The server performs postprocessing on the translation character string to generate translation result information.

The server applies format-unification processing by scanning the translation character string and adjusting punctuation, spacing, and text layout to conform to target-language conventions; for example, the server standardizes quotation marks, removes duplicated punctuation, and normalizes whitespace around punctuation.

The server further performs grammar-checking processing, using rule-based or statistical checks, to detect and correct grammatical errors and spelling mistakes.

The server modifies the translation character string based on identified issues and rewrites specific segments to satisfy grammar rules.

The server outputs translation result information as a finalized character string suitable for display on the terminal.

### Step 11:

The server transmits the translation result information to the terminal.

The server packages the translation result information into a response message, associates it with the original request identifier, and sends the message through the communication interface over the network.

The server's output is a network packet containing the translation result information, which the terminal receives as input.

### Step 12:

The terminal receives and displays the translation result information to the user.

The terminal reads the response message from the communication module and extracts the translation result information from the payload as input.

The terminal updates a display component and renders the translation text in an output area, possibly alongside the original source text.

The user observes the displayed translation and determines whether the translation is satisfactory.

The terminal outputs the displayed translation as a visual representation and may prepare feedback input fields for further user interaction.

### Step 13:

The user optionally provides evaluation information or correction information via the terminal.

The user reviews the translated text displayed on the terminal and inputs a rating, a comment, or a corrected translation into designated input fields.

The terminal captures this feedback as input and associates it with the original request information and translation result information.

The terminal outputs a feedback message containing evaluation information and/or correction information and transmits it to the server through the communication module.

### Step 14:

The server receives and stores the evaluation information or correction information as learning information.

The server accepts the feedback message via the communication interface and parses the message to extract evaluation information and correction information as input.

The server writes this information into a storage device, associating it with identifiers such as the original request, the translation condition information, and the version of the generative AI model used.

The server outputs updated stored records that become part of a dataset used for analysis and adaptation.

### Step 15:

The server analyzes the learning information and updates prompt generation and model operating conditions.

The server reads stored evaluation information and correction information from the storage device as input data for analysis.

The server computes statistics such as error frequency, occurrence of misinformation, and correlation between error types and specific prompt sentence templates or generation-condition parameters.

Based on the analysis, the server modifies template selection rules, adjusts textual content of prompt sentences (for example, adding clarifying phrases such as “in clear and accurate language”), and tunes operating conditions of the generative AI model, such as temperature and beam width, to reduce misinformation occurrence rate.

The server outputs updated configuration parameters and modified prompt sentence templates, which are used as input for subsequent translation requests, thereby continuously improving the technical behavior of the translation system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional machine translation systems that rely on statistical models or generic neural models are typically designed as one-shot text converters that map source text into target text without taking into account several important computational aspects: (i) dynamic acquisition and analysis of heterogeneous external information streams, (ii) structured generation and management of prompt sentences for a generative AI model, (iii) real-time processing constraints for audio and streaming content, and (iv) feedback loops based on user emotion signals. As a result, such systems often exhibit technical deficiencies at the computing-system level, including increased latency due to ad hoc prompt generation, unstable output behavior of the generative model leading to hallucinated or factually incorrect translations, inefficient use of processing and network resources when handling streaming data, and an inability to adapt translation style to user state without re-architecting the pipeline.

In particular, when external information is continuously acquired over communication networks, existing architectures lack a standardized, machine-enforceable mechanism for constructing and updating prompt sentences to control the behavior of a generative AI model as a translation engine. Without such a mechanism, the processor cannot reliably constrain the generative model's output distribution, resulting in higher error rates and increased need for manual post-editing. Further, typical systems treat emotion-related information merely as metadata at the user-interface layer and do not integrate emotion estimation as a first-class signal in the core translation pipeline. This separation prevents the processor from systematically adjusting translation output characteristics such as tone, emphasis, and content selection within the same computational framework that governs prompt generation and model invocation.

Moreover, conventional systems are not optimized for real-time operation over streaming audio or live content. They frequently process entire segments in batch, causing temporal misalignment between source media and translated output, and increasing end-to-end latency. Buffering and conversion stages are often implemented in an ad hoc manner without explicit coordination between audio-to-text conversion, generative model invocation, and rendering on terminal devices. As a result, subtitles and translated content are delayed or out of sync, degrading usability and imposing higher computational overhead on both server and terminal devices.

Accordingly, there is a need for an improved computer-implemented translation system in which a processor centrally manages (i) acquisition and linguistic analysis of external information, (ii) structured generation of prompt sentences for a generative AI model, (iii) conversion of audio data to textual data, (iv) real-time generation and streaming of translation result data to terminal devices, and (v) emotion-based estimation and adjustment of translation output, while constraining the generative model's output characteristics to reduce hallucinated information. Such a system should improve processing efficiency, reduce latency, increase factual reliability of generated translations, and systematically adapt the expression style and content emphasis of translation results to user emotional state, thereby improving the functioning of the underlying computer technology itself.

The specific processing by the specific processing unit 290 of the data processing device 12 in Application Example 2 is realized by the following means.

The present invention provides a server comprising a processor and at least one memory storing instructions which, when executed by the processor, cause the processor to generate a prompt sentence that instructs a generative information processing model to perform a translation process, to input the prompt sentence to the generative information processing model, to acquire information data from at least one external information supplying entity via a communication network and to analyze the acquired information data by linguistic analysis processing, to convert audio data into character string data based on the acquired information data or user interaction data, to include in the prompt sentence an instruction for converting translation target data including the character string data from a source language into a target language and to obtain translation result data from the generative information processing model, to generate display data by associating the translation result data with time information or content identification information and to transmit the display data to a terminal device, to estimate an emotional state of a user based on biometric information data or behavioral information data acquired from the terminal device, to adjust an expression style or a degree of content emphasis of the translation result data based on the estimated emotional state and the translation result data, to store adjusted translation result data in association with corresponding original information data in an information storage device and to provide the adjusted translation result data and the corresponding original information data in response to a request, and to select at least one of the original information data and the translation result data based on the estimated emotional state and contents of the acquired information data and to cause the at least one selected data to be presented on the terminal device. This enables the computing system to control the behavior of the generative information processing model through structured prompt sentences, to perform real-time and emotion-aware translation with reduced generation of factually incorrect information, to synchronize translated output with streaming content, and to adapt translation style and content selection within a unified server-side pipeline, thereby improving overall performance, reliability, and efficiency of computer-based multilingual information processing.

The term “processor” refers to a hardware computation unit or a combination of hardware computation units, such as a central processing unit, a graphics processing unit, or a dedicated logic circuit, that executes instructions to perform data processing operations described in this specification.

The term “memory” refers to a hardware storage component, such as a volatile or non-volatile storage device, that stores instructions and data for access and execution by the processor.

The term “generative information processing model” refers to a machine-learned model configured to generate output data, including translated text, in response to input data and a prompt sentence, based on patterns learned from training data.

The term “prompt sentence” refers to a machine-readable instruction string that specifies to the generative information processing model a task to be performed, a target language, a style or tone, and one or more constraints for generating translation result data.

The term “translation process” refers to an operation in which text or text-equivalent data in a source language is converted into text in a target language while preserving at least semantic content of the original text.

The term “information data” refers to digital data representing content obtained from an external information supplying entity, including but not limited to text data, audio data, video data, metadata, or structured records.

The term “external information supplying entity” refers to a logical or physical source of information external to the server, such as an information service, content provider, or data feed, that provides information data via a communication network.

The term “linguistic analysis processing” refers to computational processing applied to text or text-equivalent data, including at least one of language detection, tokenization, part-of-speech tagging, syntactic parsing, semantic analysis, or topic classification.

The term “audio data” refers to digital signals representing sound, including speech signals captured by a sensor such as a microphone and encoded in a digital format.

The term “character string data” refers to text data represented as a sequence of characters encoded in a character encoding scheme, and obtained by converting audio data or other non-text data.

The term “translation target data” refers to data that serves as input content to be translated by the generative information processing model, the data including at least character string data in a source language.

The term “source language” refers to a natural language in which translation target data is originally expressed prior to being translated into a target language.

The term “target language” refers to a natural language into which translation target data in a source language is converted by the translation process.

The term “translation result data” refers to digital text or text-equivalent data generated by the generative information processing model as a result of performing the translation process on translation target data.

The term “display data” refers to data formatted for presentation on a user interface of a terminal device, the data including at least translation result data and optionally associated time information or content identification information.

The term “time information” refers to data indicating temporal positions or intervals associated with translation result data, such as timestamps or time codes, used for synchronizing translated output with audio or video content.

The term “content identification information” refers to data that uniquely or semi-uniquely identifies a segment of content, such as an identifier, index, or key associated with a corresponding part of information data or translation result data.

The term “terminal device” refers to an end-user computing device, such as a mobile computing device, a head-mounted display, a personal computer, or a display apparatus, that communicates with the server and presents content to a user.

The term “user interaction data” refers to data derived from user operations or behaviors on a terminal device, including but not limited to input events, navigation events, selection operations, or interaction histories.

The term “biometric information data” refers to data representing a physical or physiological characteristic of a user, such as facial image data, voice data, or other sensor measurements that can be used to estimate an emotional state.

The term “behavioral information data” refers to data representing user actions, patterns, or usage behaviors, including reading patterns, browsing actions, response times, or interaction frequencies, collected through the terminal device.

The term “emotional state” refers to a state representing an affective condition of a user, such as joy, sadness, anger, fear, calmness, or a combination thereof, estimated based on biometric information data or behavioral information data.

The term “expression style” refers to stylistic characteristics of text output, including but not limited to tone, formality, politeness level, sentiment orientation, or register, as applied to translation result data.

The term “degree of content emphasis” refers to a relative weighting or highlighting of particular portions, entities, or aspects within translation result data, including emphasis on specific topics, sentiments, or informational elements.

The term “original information data” refers to information data in its initial or non-translated form, prior to generation of translation result data, and associated with the translation result data in storage.

The term “information storage device” refers to a hardware storage subsystem, such as a database system, file system, or other persistent storage, configured to store original information data, translation result data, and associated metadata.

The term “communication network” refers to a wired or wireless network infrastructure that enables data exchange between the server, the external information supplying entity, and the terminal device.

The term “output control conditions” refers to parameters or constraints applied to the generative information processing model, such as configuration values, sampling strategies, or decoding rules, that influence characteristics of generated output.

The term “probabilistic distribution parameters” refers to numerical parameters used by the generative information processing model to control probability distributions over candidate output tokens or sequences during generation.

The term “factually incorrect information” refers to generated content that does not accurately represent underlying facts present in original information data or external reference information and that is not merely a stylistic variation.

The term “real-time translation processing” refers to translation processing in which translation result data is generated and provided to the terminal device with sufficiently low latency such that the translation remains temporally aligned with ongoing content presentation.

The term “sequentially and continuously provided” refers to an operation in which translation result data is generated in segments over time and delivered in an ordered and ongoing manner to the terminal device while source content is being acquired or presented.

In one embodiment, a server cooperates with at least one terminal to provide emotion-aware, real-time translation of information obtained from external information supplying entities. The server comprises at least one processor and at least one memory storing instructions that, when executed, implement the functional blocks described below. The terminal comprises at least one processor, at least one memory, at least one display device, and at least one sensor such as a microphone or camera. A user operates the terminal to consume translated content and to generate interaction and biometric data that are used by the server to adapt translation behavior.

Server implements a modular software architecture that includes at least: a network interface module, an information acquisition and analysis module, an audio-to-text conversion module, a prompt generation and control module, a generative AI inference module, an emotion estimation module, a translation post-processing and adjustment module, a data storage and retrieval module, and a presentation control module. Terminal implements at least: a user interface module, an audio capture module, a biometric capture module, a local buffering and encoding module, and a rendering module.

Server uses conventional computing hardware such as a multi-core central processing unit and, in some embodiments, an accelerator such as a graphics processing unit or tensor processing unit for executing neural network inference. Server uses a persistent storage subsystem such as a relational database management system to store original information data, translation result data, prompt sentences, emotion labels, and metadata. Terminal uses operating system APIs for hardware access, including an audio capture API, a camera capture API, and a display API.

Server uses a generative AI model that is implemented as a neural network having, for example, a transformer-based architecture with multiple self-attention layers, feed-forward layers, and layer-normalization components. The generative AI model is parameterized by a plurality of weight matrices and bias vectors, and is trained by a supervised or semi-supervised learning procedure on multilingual corpora. The training procedure uses a loss function such as cross-entropy over token sequences, an optimization algorithm such as stochastic gradient descent with adaptive learning rate, and regularization mechanisms such as dropout and weight decay. During training, server (or an external training system) minimizes the loss function by iteratively computing gradients of the loss with respect to the network parameters and updating the parameters according to the optimization algorithm. The trained generative AI model thus learns conditional probability distributions over token sequences that capture translation mappings and style patterns across languages.

Server uses specific software libraries and services to implement the individual functions. Server, in one embodiment, uses a speech recognition service to convert audio data into character string data. Such a service can be provided by a generic cloud-based speech-to-text API, which itself employs an acoustic model, a language model, and decoding logic based on beam search. Server uses a natural language processing library such as a general-purpose text analysis toolkit to perform language detection, tokenization, part-of-speech tagging, and entity identification for text segments acquired from external information supplying entities.

Server uses a database management system such as a relational database engine to persistently store original texts, translations, and associated time codes or content identifiers.

Server uses a prompt generation and control module to construct prompt sentences for the generative AI model. The prompt sentences have a structured format that includes at least a task instruction, a source language indication, a target language indication, optional style and tone constraints, and the translation target data. For example, server may construct a prompt sentence:

“Translate the following English text to Japanese: ‘Welcome to our live stream. Today, we will discuss the latest trends in technology.’”

or

“Translate the following article from English to Japanese: article body text”

or

“Translate the following article about the latest technology trends into Japanese, considering the user's emotional state of excitement.”

Server uses an internal representation of the prompt sentence as a token sequence, and the generative AI model consumes this sequence as input to generate a sequence of output tokens representing the translation result data.

Server uses the prompt generation and control module not only to specify translation direction but also to constrain the behavior of the generative AI model. Server sets generation parameters, such as sampling temperature, top-k or top-p sampling thresholds, maximum output length, and penalties for repetition, in a way that reduces the likelihood of producing factually incorrect information. For example, server sets a low temperature and a constrained sampling distribution for translation prompts, which biases the model toward higher probability, more deterministic outputs that are more likely to correspond to faithful translations. Server thereby optimizes the statistical properties of the generative process to reduce hallucinated content.

Server uses the emotion estimation module to compute an emotional state for the user based on biometric information data and behavioral information data transmitted from the terminal.

In one embodiment, terminal captures a sequence of facial images using its camera and streams the images, or extracted features such as facial landmark vectors, to the server.

Additionally, terminal collects voice audio samples while the user reacts to content, and terminal or server computes acoustic features such as pitch contours, energy, and spectral descriptors. Server can further analyze user interaction logs, including scrolling speed, pause durations, and selection patterns, to infer engagement or stress levels. Server inputs this multimodal feature data into an emotion classifier, which can be a neural network such as a convolutional network for images and a recurrent or transformer network for sequential features, trained to output probability distributions over discrete emotion labels such as joy, sadness, anger, or neutrality. Server then selects an emotional state based on the highest probability or a thresholded combination of probabilities.

Server uses the translation post-processing and adjustment module to modify expression style or content emphasis of translation result data in response to the estimated emotional state. Server may, for example, maintain a set of style transformation rules or auxiliary models. In one implementation, server constructs a second prompt sentence that instructs the generative AI model to rewrite or refine an already translated text according to an indicated emotion. For example, server can use a prompt sentence:

“Rewrite the following Japanese translation in a tone suitable for a joyful user, without changing the factual content: <translated_text>”

or

“Translate the following article accurately and adjust the tone based on the user's detected emotion: original text”

or

“Translate the following article into Japanese and adjust the tone based on the user's emotion: Article Text. The user is feeling Emotion.”

Server inputs this prompt sentence and the intermediate translation result data to the generative AI model. Because the architecture is a transformer with contextual attention, the model can incorporate the emotion and style instructions encoded in the prompt sentence into its decoding process. Server thereby obtains adjusted translation result data that preserves the factual content while changing lexical choices, sentence endings, or polite forms to match the emotional state.

Server uses data structures specifically designed to support real-time alignment and efficient retrieval. For streaming content, server represents translation result data as a collection of segments, each segment having fields including segment identifier, start time code, end time code, source text, translated text, emotion label, and quality score. Server stores such segments in a table indexed by content identifier and time code, allowing efficient retrieval of the appropriate segments when the terminal requests display data for a given time window. Server, in some embodiments, compresses segments or batches segments for transmission to reduce communication load.

Terminal uses its audio capture module to encode user's speech or external audio (for example, from a live stream) into digital audio frames using a codec such as pulse-code modulation or a compressed audio encoding. Terminal uses its local buffering and encoding module to group several frames into packets and attach timestamps before sending them over a communication network to the server. This arrangement allows server to map received audio packets to approximate playback times. Terminal uses its biometric capture module to capture image frames from a user-facing camera and to encode them for efficient network transmission, optionally pre-processing them into feature descriptors to reduce bandwidth usage.

User uses the terminal's user interface module to select languages, start or stop translation sessions, choose among original information data and translated variants, and provide feedback on translation quality. Terminal displays controls that allow the user to switch between viewing original text and translation, adjust subtitle size and position, and opt in or out of emotion-based adaptation.

Server uses the information acquisition and analysis module to retrieve information data from external information supplying entities. For example, server uses a REST interface to request recent articles from a news provider or to poll a feed service for updates. Server receives data in a structured format such as a generic markup or serialization format and parses fields including title, body, author, timestamp, and source identifier. Server then processes the body text with the natural language processing library to detect source language, to segment the text into sentences, and to detect named entities. Server stores the parsed records in a database table that includes primary keys, foreign keys to source entities, and index fields for language and topic.

Server uses the generative AI inference module to apply the generative AI model to translation targets. The module handles tokenization and detokenization using a subword encoding such as byte-pair encoding or a similar algorithm. Server converts each prompt sentence and associated translation target data into sequences of integer token identifiers, organizes them into a batch if needed, and forwards them to the generative AI model. The model processes the inputs by sequentially applying attention layers and feed-forward layers according to the transformer's architecture and outputs a distribution over next-token candidates at each decoding step. The inference module then selects tokens based on the controlled sampling strategy configured for translation tasks. Server reconstructs the translated text from the sequence of tokens and returns it to the post-processing pipeline.

Server improves computing performance and data management through the above design.

Because server centralizes prompt generation and emotion-aware adjustments, and because server encodes system-level constraints into the prompt sentence and model parameters, server reduces the number of expensive inference calls. For example, server can generate both translation and stylistic adaptation in a single forward pass by instructing the generative AI model through an integrated prompt sentence rather than performing separate translation and re-writing operations. This reduces overall computational load and latency.

Server improves accuracy by incorporating linguistic analysis results and emotion estimates into the construction of prompt sentences and into the control of generation parameters. By constraining temperature and sampling strategies and by including explicit instructions to avoid adding extra information, server reduces the probability mass assigned to hallucinated outputs. By storing original and translated segments with time codes and aligning them through the database index, server ensures that subtitles and translations are synchronized with the source media, which is a technical improvement over naive batching approaches.

Server improves communication efficiency by segmenting translation result data into time-aligned units and transmitting only the units relevant to the user's current playback position.

Server can also adapt segment sizes and batching strategies based on network conditions, thereby reducing unnecessary retransmission or buffering overhead. This is different from a simple content delivery scheme because the server dynamically controls segment generation based on both the decoding state of the generative AI model and the playback state reported by the terminal.

Terminal, in some embodiments, caches recently received translation segments and emotion labels. Terminal can continue to display contextually appropriate translations even if brief connectivity interruptions occur, thus improving robustness. Terminal can also locally smooth emotion signals over time to avoid rapid fluctuations in style, thereby reducing visual and cognitive noise for the user.

The described system architecture provides several technical variants. Server, in another embodiment, implements the generative AI model locally on dedicated accelerator hardware instead of invoking a remote service. Server, in another embodiment, uses a different neural network architecture, such as a sequence-to-sequence encoder-decoder model with attention, while still employing structured prompt sentences as control signals appended to the encoder input. Server, in another embodiment, augments the generative AI model with a separate factual verification component that compares named entities and numbers in the translation result data with those in the original information data, and server adjusts decoding penalties if discrepancies exceeding a threshold are detected. Server, in a further embodiment, integrates a rule-based post-filter that enforces domain-specific terminology mapping using a dictionary, providing additional control that cannot be practically achieved by human translators operating manually at real-time speeds.

User, under these embodiments, benefits from improved translation latency, higher factual consistency, and emotionally adapted presentation without being aware of internal details.

Terminal acts as a sensing and rendering endpoint, while server orchestrates complex computations and data operations that go beyond simple automation of human translation.

Because server mathematically optimizes model parameters, dynamically constructs and controls prompt sentences, and uses specialized data structures for segmenting and synchronizing translation result data, the system produces measurable improvements in processing speed, translation accuracy, synchronization, and communication efficiency, thereby improving the functioning of the underlying computer technology.

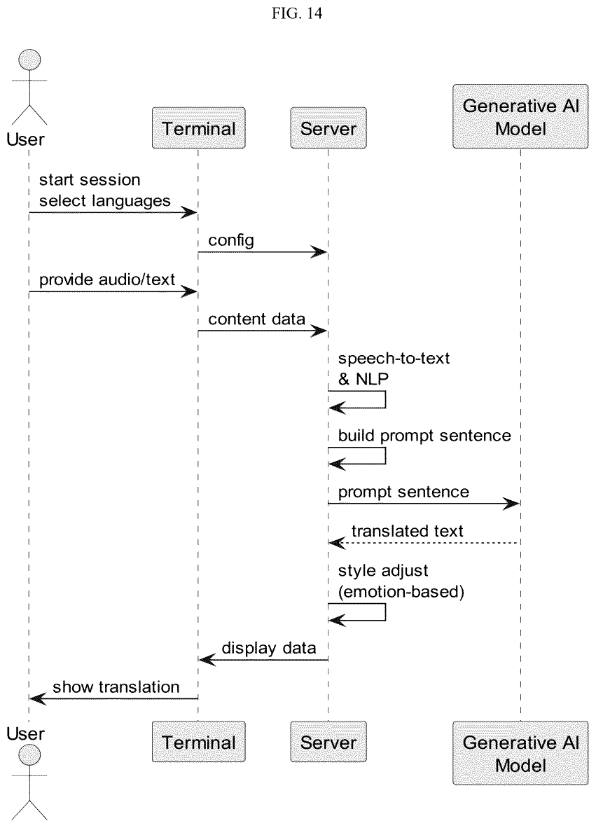

The following describes the processing flow using FIG. 14.

### Step 1:

User initiates a translation session on the terminal.

User operates the terminal to launch a translation application and select a source language and a target language.

Input: User selection of source language, target language, and translation mode (for example, live speech translation or article translation).

Output: Mode setting data and language setting data stored in the terminal.

Terminal stores these settings in local memory and prepares configuration data that will be attached to subsequent requests to the server.

### Step 2:

Terminal acquires content and user-related data.

Terminal, depending on the selected mode, captures audio data through a microphone, receives text or article data through a browser or application interface, and optionally captures biometric information data such as facial images or voice segments.

Input: Acoustic signals from a microphone, text or article data from user input or external content, and biometric signals from a camera or other sensors.

Output: Encoded audio frames, text payloads, and sensor data packets.

Terminal converts raw sensor signals into digital formats, for example, 16-bit PCM for audio and compressed image frames for video, and groups them into packets with timestamps and session identifiers.

### Step 3:

Terminal transmits captured data to the server.

Terminal uses a network communication module to send encoded audio frames, text payloads, mode setting data, and language setting data to the server via a secure communication channel.

Input: Encoded audio frames, text payloads, sensor data packets, and configuration data.

Output: Network request messages containing session information and content data delivered to the server.

Terminal attaches metadata such as content type, language hint, and time codes to each message to enable correct processing on the server side.

### Step 4:

Server receives and pre-processes incoming data.

Server uses a network interface module to receive the request messages, separates audio data, text data, and biometric or behavioral data, and stores them temporarily in buffers or staging tables.

Input: Network request messages containing encoded audio frames, text payloads, and sensor data packets.

Output: Structured internal data objects representing audio segments, text segments, and user context records.

Server parses headers to extract session identifiers, languages, and timestamps, and organizes the data into data structures indexed by session and time.

### Step 5:

Server converts audio data to character string data.

Server invokes an audio-to-text conversion module, which calls a speech recognition engine to transform audio segments into text.

Input: Encoded audio segments with associated time codes and language hints.

Output: Character string data representing recognized speech, annotated with time codes.

Server sends the audio segments to the speech recognition engine, receives recognized token sequences and confidence scores, and performs post-processing operations such as punctuation insertion and sentence boundary detection to generate coherent text segments.

### Step 6:

Server performs linguistic analysis on text data.

Server applies a natural language processing library to both recognized speech text and text articles obtained from external information supplying entities.

Input: Character string data representing recognized speech or externally acquired text, along with language information.

Output: Linguistically analyzed text objects containing language labels, token lists, part-of-speech tags, sentence boundaries, and named entity annotations.

Server runs operations such as tokenization, language detection verification, part-of-speech tagging, and entity recognition, and stores the resulting annotations in associated data structures.

### Step 7:

Server estimates user emotional state from biometric and behavioral data.

Server uses an emotion estimation module to process facial image features, voice features, and interaction logs.

Input: Biometric information data (for example, facial images and voice segments) and behavioral information data (for example, scrolling patterns and interaction timings).

Output: An emotional state label or probability distribution over multiple emotional states associated with the current session.

Server extracts features such as facial landmarks, facial action units, prosodic features, and temporal behavior metrics, feeds these features into an emotion classifier, and computes an emotional state value used for subsequent translation adjustment.

### Step 8:

Server constructs a prompt sentence for the generative AI model.

Server uses a prompt generation module to assemble a prompt sentence that encodes translation instructions, language specifications, and, when appropriate, emotion-related style constraints.

Input: Linguistically analyzed text objects, language setting data, and emotional state information.

Output: A prompt sentence string ready to be tokenized and input into the generative AI model.

Server selects a template and fills in placeholders, for example:

“Translate the following English text to Japanese: ‘<source_text>’”

or

“Translate the following article from English to Japanese: article body text”

or

“Translate the following article about the latest technology trends into Japanese, considering the user's emotional state of excitement.”

Server thereby generates a text instruction that controls how the generative AI model processes the translation target data.

### Step 9:

Server tokenizes the prompt sentence and prepares model input.

Server uses a tokenizer compatible with the generative AI model to convert the prompt sentence and associated text into token identifiers.

Input: Prompt sentence string and translation target text.

Output: A sequence or batch of token identifiers representing the model input.

Server applies subword segmentation, maps each subword to an integer token, adds special tokens such as start-of-sequence or end-of-sequence markers, and packages the tokens with model configuration parameters and attention masks.

### Step 10:

Server invokes the generative AI model to generate translation result data.

Server passes the tokenized prompt and configuration parameters such as temperature and maximum output length to the generative AI model hosted locally or remotely.

Input: Tokenized prompt sequence, model configuration parameters, and, when applicable, constraints on sampling such as top-k or top-p values.

Output: A sequence of token identifiers representing the translated text, along with metadata such as log probabilities or attention scores.

Server runs inference through the neural network, obtains probability distributions over candidate tokens at each time step, selects tokens according to the configured decoding strategy, and aggregates them into an output sequence.

### Step 11:

Server detokenizes and post-processes translation result data.

Server converts the output token identifiers back into a character string and applies normalization rules to produce readable text.

Input: Sequence of token identifiers generated by the generative AI model.

Output: Translation result text in the target language, optionally annotated with quality indicators.

Server performs detokenization, spacing adjustments, symbol normalization, and optional heuristic corrections such as replacing placeholders with known entity translations, and then associates the translated segments with corresponding source segments.

### Step 12:

Server adjusts translation expression style and content emphasis based on emotional state.

Server uses a translation post-processing and adjustment module to adapt the translation according to the user's emotional state.

Input: Translation result text, emotional state label, and optional style rules or secondary prompt templates.

Output: Adjusted translation text that preserves factual content but reflects a tone and emphasis suited to the emotional state.

Server may construct a secondary prompt sentence such as:

“Rewrite the following Japanese translation in a tone suitable for a joyful user, without changing the factual content: <translated_text>”

and feed this into the generative AI model, or apply rule-based transformations that modify sentence endings, politeness level, or lexical choices. The resulting text is then stored as the final translation for presentation.

### Step 13:

Server associates translation data with time information and content identifiers.

Server links each translation segment to corresponding time codes, segment identifiers, and original information references.

Input: Adjusted translation text segments, time information, and content identification information.

Output: Segment records containing fields for source text, translated text, timestamps, identifiers, and emotion labels.

Server inserts or updates rows in a database table or in-memory index, enabling efficient retrieval of translation segments for specific content and time ranges.

### Step 14:

Server generates display data for the terminal.

Server formats translation segments into a representation suitable for rendering subtitles or article views on the terminal.

Input: Segment records selected for a particular user session or content item.

Output: Display data structures including text strings, styling attributes, positions, and timing metadata.

Server constructs subtitle tracks or document layouts with time-aligned cues, font specifications, and region coordinates, and encapsulates this information into response messages addressed to the terminal.

### Step 15:

Server transmits display data and optional feedback prompts to the terminal.

Server uses the network interface module to send formatted display data and, optionally, prompts requesting user feedback on translation quality.

Input: Display data structures and session identifiers.

Output: Response packets containing translation content, layout instructions, and optional feedback interface descriptions.

Server may compress data, aggregate multiple segments into a single response, and schedule transmission to match the terminal's playback position and bandwidth conditions.

### Step 16:

Terminal receives display data and renders translated content.

Terminal uses its rendering module to interpret the display data and draw translated text on the display device.

Input: Response packets containing text strings, timing metadata, and styling instructions.

Output: Visual presentation of subtitles, translated articles, or other translated content on the terminal screen.

Terminal aligns the display of subtitles with local playback time codes, applies font and style settings, and updates the screen in synchronization with incoming segments.

### Step 17:

User consumes translated content and optionally provides feedback.

User reads the translated text or subtitles as they appear on the terminal screen and compares them with the original content if desired.

Input: Visual presentation of translated content and, optionally, interactive controls for rating or commenting.

Output: User comprehension of foreign-language information and, when provided, explicit feedback signals.

User may indicate satisfaction or dissatisfaction with translations, and the terminal captures this feedback as interaction data and sends it back to the server.

### Step 18:

Server updates model control parameters and system behavior based on feedback and performance.

Server analyzes user feedback, error rates, latency measurements, and emotion estimation accuracy to adapt future processing.

Input: Feedback data from the terminal, performance logs, and stored translation and emotion records.

Output: Updated configuration parameters for the generative AI model, prompt templates, emotion classifier thresholds, and resource allocation policies.

Server may lower or raise temperature settings, modify prompt sentences to emphasize factual fidelity, retrain or fine-tune parts of the generative AI model or emotion classifier on logged data, and adjust batching and segmentation sizes to improve throughput and reduce latency in subsequent sessions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

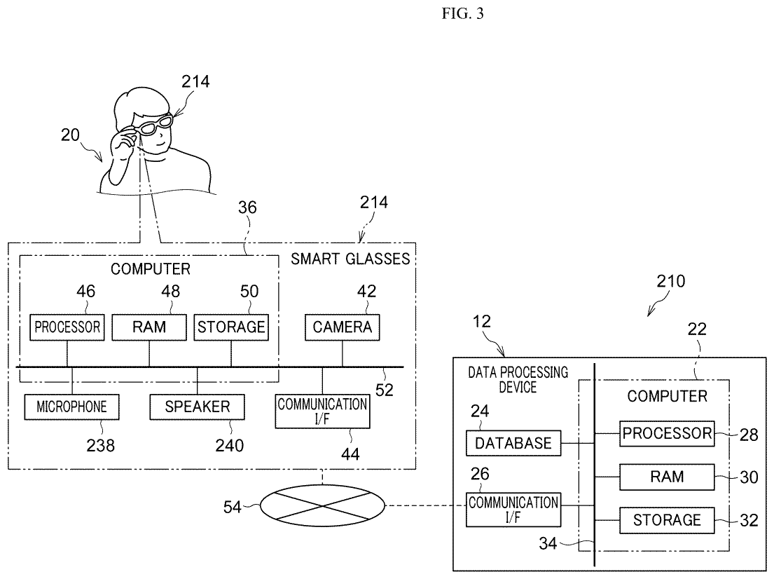

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

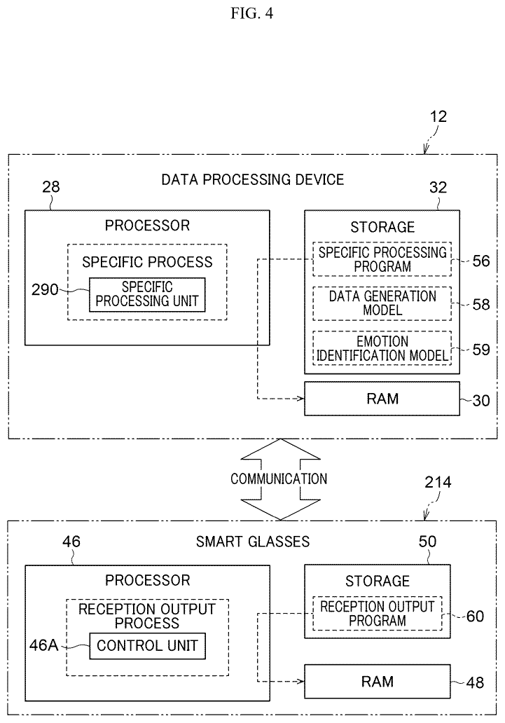

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

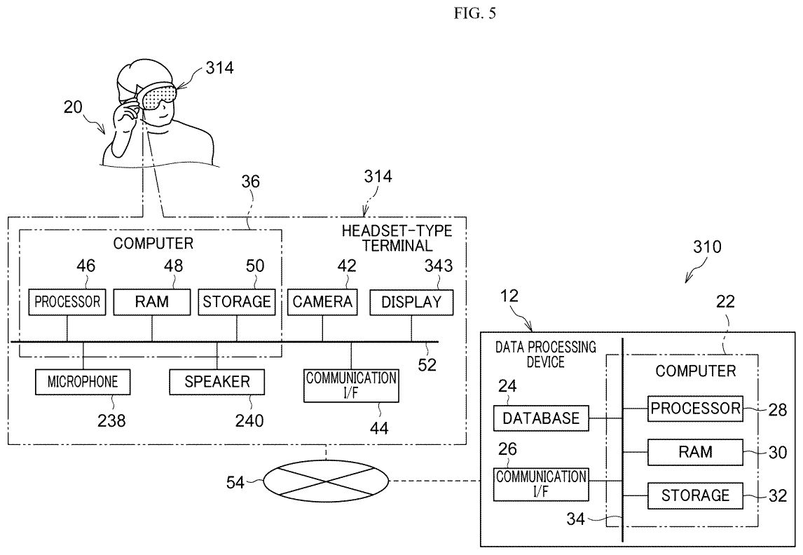

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

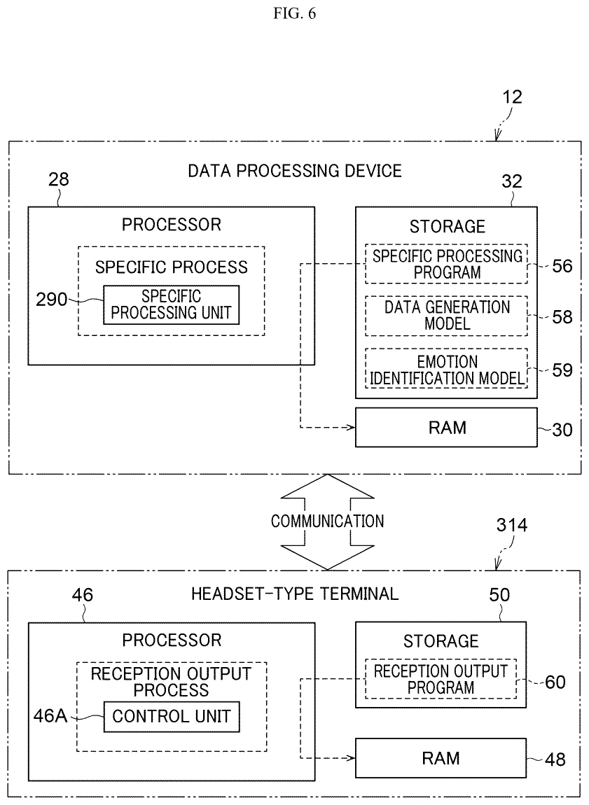

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

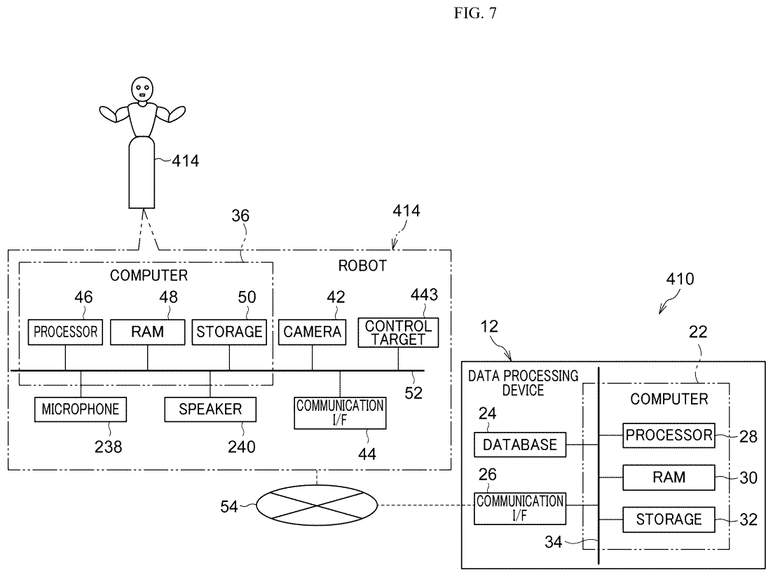

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

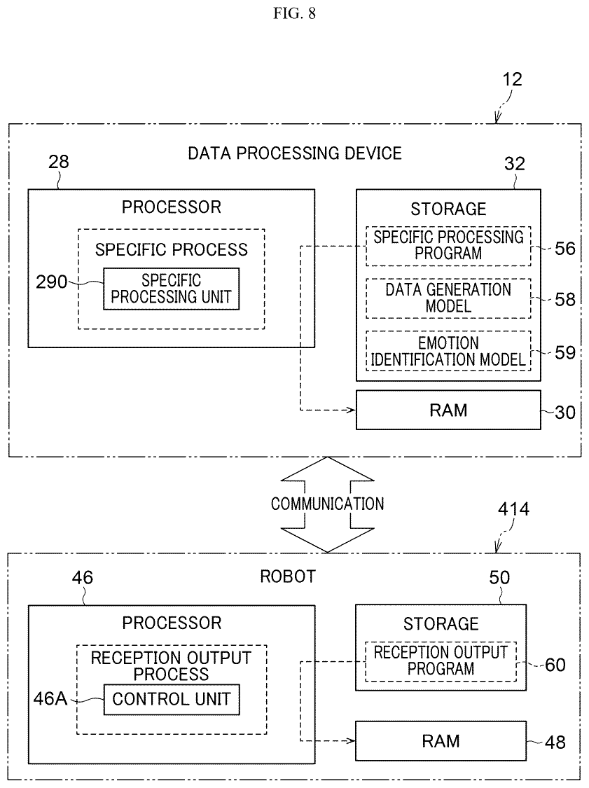

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

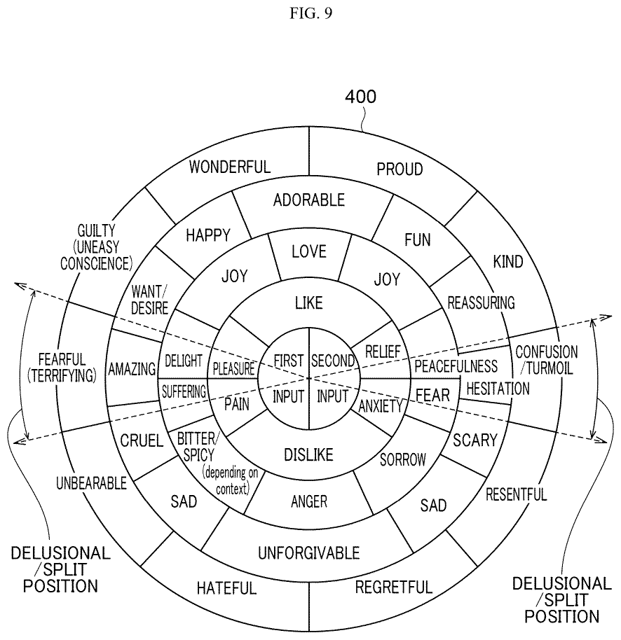

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

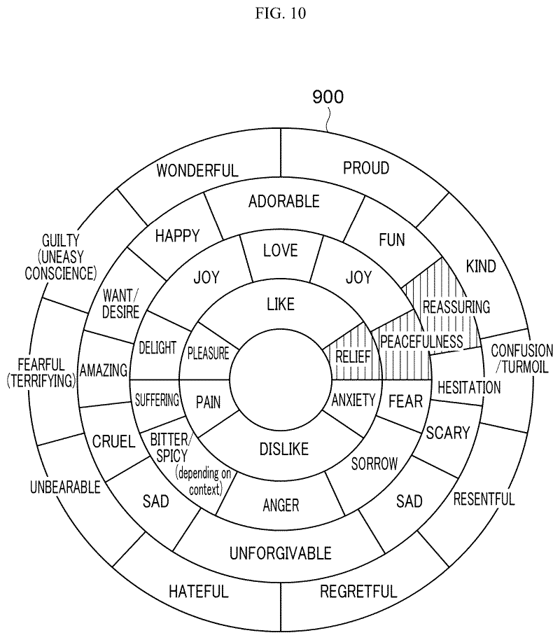

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
generate a prompt sentence for causing a generative information processing apparatus to execute translation processing and to input the prompt sentence into the generative information processing apparatus, and
receive character information from an external information source via a communication network, convert the character information into an internal format, and hold the converted character information, and
associate translation information output from the generative information processing apparatus with original information received from the external information source and store the associated information in an information storage structure of a storage device, and
receive an acquisition request from an information browsing terminal, acquire the original information and the translation information from the storage device, and transmit the acquired information to the information browsing terminal, and
cause the information browsing terminal to generate a display screen capable of parallel display or switchable display of the original information and the translation information and to accept a selection operation by a user entity, and
analyze an emotional state or reaction information of the user entity and adjust at least one of the prompt sentence and an output format of the translation information, and
set at least one of a description content of the prompt sentence and a control condition of the generative information processing apparatus based on operation characteristics of the generative information processing apparatus so as to reduce a probability of occurrence of misinformation.

### Supplementary 2

The system according to supplementary 1,
wherein the processor is configured to
update at least one of a control parameter and an operation setting value in internal arithmetic processing of the generative information processing apparatus based on statistical information or evaluation information so that the generative information processing apparatus exhibits a characteristic in which misinformation is less likely to occur.

### Supplementary 3

The system according to supplementary 1,
wherein the processor is configured to
automatically generate, at a time of reception or immediately after reception of the character information from the external information source, a prompt sentence for causing real-time execution of translation processing, and to sequentially input the prompt sentence and the character information into the generative information processing apparatus.

### Application Example 1

### Supplementary 1

A system comprising a processor and a storage device,
wherein the processor is configured to
generate a prompt sentence to cause a generative information processing apparatus to execute a translation process, and input the prompt sentence to the generative information processing apparatus,
acquire original text information from an external information supply apparatus and store the original text information in the storage device in association with metadata,
generate a prompt sentence including the original text information, transmit the prompt sentence to the generative information processing apparatus, obtain translated text information from the generative information processing apparatus, and store the translated text information in the storage device in association with the original text information, transmit the original text information and the translated text information to a portable information terminal in response to an acquisition request from the portable information terminal,
and detect an emotional state of a user and adjust at least one of the prompt sentence and the translated text information based on the emotional state of the user.

### Supplementary 2

The system according to supplementary 1,
wherein the processor is configured to optimize control parameters of a generative information processing model in the generative information processing apparatus such that an operational characteristic of the generative information processing model exhibits a reduced tendency to output incorrect information.

### Supplementary 3

The system according to supplementary 1,
wherein the processor is configured to, upon receipt of the original text information from the external information supply apparatus, generate the prompt sentence and input the prompt sentence to the generative information processing apparatus in real time to cause generation of the translated text information.

### Example 2

### Supplementary 1

A system comprising a processor,
wherein the processor is configured to
obtain, from an external terminal, request information including character information to be translated and translation condition information, and perform preprocessing on the character information to be translated by executing normalization processing and unnecessary-character removal processing, and
generate, based on the preprocessed character information to be translated and the translation condition information, a prompt sentence for translation instruction in accordance with translation direction information and field information, and construct input information for a generative AI model by combining the prompt sentence with the preprocessed character information to be translated, and
execute encoding processing to convert the input information into a code sequence, invoke the generative AI model using the code sequence, and cause the generative AI model to generate a translation character string by numerical computation processing, and
perform postprocessing on the translation character string obtained from the generative AI model, the postprocessing including format-unification processing and grammar-checking processing, and transmit postprocessed translation result information to the external terminal, and
obtain, from the external terminal, evaluation information or correction information regarding the translation result information, store the evaluation information or the correction information in a storage device, and use the evaluation information or the correction information as learning information to update processing for generating the prompt sentence or operating conditions of the generative AI model.

### Supplementary 2

The system according to supplementary 1,
wherein the processor is configured to
analyze output characteristics of the generative AI model based on the evaluation information or the correction information, and optimize internal parameters of the generative AI model or generation-condition parameters of the generative AI model so as to reduce a misinformation occurrence rate.

### Supplementary 3

The system according to supplementary 1,
wherein the processor is configured to
sequentially execute the normalization processing and the processing for generating the prompt sentence upon receipt of the request information, provide the input information sequentially to the generative AI model, cause at least a part of the translation character string to be generated in real time, and transmit the translation character string to the external terminal in a stepwise manner.

### Application Example 2

### Supplementary 1

A system comprising a processor,
wherein the processor is configured to
generate a prompt sentence for instructing a generative information processing model to perform a translation process and input the prompt sentence to the generative information processing model,
acquire information data from an external information supplying entity and analyze the information data by linguistic analysis processing,
convert audio data into character string data based on the information data or user interaction data,
include an instruction for converting translation target data including the character string data from a source language into a target language in the prompt sentence, input the prompt sentence to the generative information processing model, and obtain translation result data from the generative information processing model,
generate display data by associating the translation result data with time information or content identification information and transmit the display data to a terminal device,
estimate an emotional state of a user based on biometric information data or behavioral information data acquired from the terminal device,
adjust an expression style or a degree of content emphasis of the translation result data based on the emotional state and the translation result data,
store adjusted translation result data in association with corresponding original information data in an information storage device and provide the adjusted translation result data and the corresponding original information data in response to a request, and
select at least one of the original information data and the translation result data based on the emotional state and contents of the information data and cause the at least one selected data to be presented on the terminal device.

### Supplementary 2

The system according to supplementary 1,
wherein the processor is configured to adjust output control conditions or probabilistic distribution parameters set for the generative information processing model so as to optimize generation characteristics of the translation result data and reduce a possibility of generating information that is different from factual information.

### Supplementary 3

The system according to supplementary 1,
wherein the processor is configured to, when the information data is received via a communication path or when the audio data is acquired, include a condition requesting real-time translation processing in the prompt sentence, input the prompt sentence to the generative information processing model, and cause the translation result data to be generated sequentially and provided continuously to the terminal device.

What is claimed is:

1. A system comprising:
circuitry configured to:
acquire, via a communication interface coupled to a packet-switched network, character data from an external data source, and generate, for each item of the character data, a prompt sentence that specifies translation processing instructions for a generative neural network model;
input the prompt sentence and the character data to the generative neural network model, and receive translation data output by the generative neural network model;
associate the translation data with corresponding original character data in a structured storage architecture of a storage device, and control transmission of both the original character data and the translation data to a terminal device such that the terminal device performs parallel or switchable display of the original character data and the translation data;
analyze emotional state data or reaction data associated with a user of the terminal device, and adjust at least one of a content of the prompt sentence or an output format of the translation data based on a result of the analysis; and
set at least one of a description content of the prompt sentence, a control parameter, or an operation setting value of the generative neural network model based on operational characteristics, statistical data, or evaluation data of the generative neural network model to reduce a probability that erroneous output data is generated.

2. The system according to claim 1, wherein the circuitry is configured to automatically generate the prompt sentence at a time of reception of the character data from the external data source, and sequentially input the prompt sentence and the character data to the generative neural network model to cause real-time execution of translation processing.

3. The system according to claim 2, wherein the circuitry is configured to monitor a reception rate of character data from the external data source, adaptively schedule prompt sentence generation and model inference based on the reception rate, and buffer received character data in the storage device when the reception rate exceeds a processing throughput threshold.

4. The system according to claim 3, wherein the circuitry is configured to apply a priority assignment algorithm to buffered character data based on a data freshness metric, process higher-priority character data items first, and transmit corresponding translation data to the terminal device in priority order.

5. The system according to claim 1, wherein the circuitry is configured to generate the prompt sentence by selecting a translation instruction template based on a detected language pair, substituting the character data and output format specifications into the template, and appending control instructions specifying a desired translation style and accuracy constraints.

6. The system according to claim 5, wherein the circuitry is configured to adjust the control instructions in the prompt sentence based on the emotional state data by increasing a simplification parameter when an emotional state parameter indicates an elevated difficulty-perception state, and increasing a formality parameter when the emotional state parameter indicates a formal-context state.

7. The system according to claim 6, wherein the circuitry is configured to apply a temperature reduction operation to a sampling parameter of the generative neural network model based on the operational characteristics or evaluation data to reduce output variance, and verify the translation data against a consistency metric before storing in the storage device.

8. The system according to claim 7, wherein the circuitry is configured to apply a hallucination detection algorithm to the received translation data by comparing key entity terms in the translation data against a reference lexicon, flag translation data items containing unrecognized entity terms, and regenerate flagged translation data items by supplying a correction prompt sentence to the generative neural network model.

9. The system according to claim 1, wherein the circuitry is configured to apply an emotion recognition algorithm to at least one of facial expression data, voice data, or interaction pattern data received from the terminal device to generate the emotional state data, classify the emotional state data into one of a plurality of emotional state categories, and select a prompt sentence adjustment strategy based on the classified emotional state category.

10. The system according to claim 9, wherein the circuitry is configured to detect a change in the emotional state data exceeding a state-change threshold between consecutive processing cycles, regenerate the prompt sentence incorporating the updated emotional state data as a translation style condition, and supply the regenerated prompt sentence to the generative neural network model.

11. The system according to claim 1, wherein the circuitry is configured to store the association between original character data and translation data in a key-value storage structure indexed by a content identifier and a timestamp, retrieve stored associations by content identifier in response to a retrieval request from the terminal device, and transmit the retrieved original character data and translation data to the terminal device.

12. The system according to claim 11, wherein the circuitry is configured to generate an updated translation data item for stored original character data items when the control parameter or the operation setting value of the generative neural network model is updated, replace the stored translation data item with the updated translation data item in the storage device, and transmit the updated translation data item to the terminal device.

13. The system according to claim 1, wherein the circuitry is configured to accumulate statistical data comprising output confidence scores, correction rates, and hallucination frequencies from prior translation processing cycles, apply a parameter optimization algorithm to the accumulated statistical data to compute updated control parameter values, and apply the updated control parameter values to the generative neural network model.

14. The system according to claim 13, wherein the circuitry is configured to apply the parameter optimization algorithm using a gradient-based update rule that minimizes a combined loss function incorporating hallucination frequency, confidence score variance, and user correction rate, and store the updated control parameter values in the storage device for application to subsequent translation processing cycles.

15. The system according to claim 1, wherein the circuitry is configured to receive a user correction input from the terminal device identifying an error in the translation data, store the user correction input as evaluation data in the storage device, update the content of the prompt sentence based on the stored evaluation data, and apply the updated prompt sentence to subsequent translation processing of similar character data.

16. The system according to claim 15, wherein the circuitry is configured to aggregate user correction inputs across a plurality of user sessions to compute correction frequency statistics, apply a batch parameter update to the generative neural network model based on the correction frequency statistics, and reduce a probability of recurrence of identified error patterns.

17. The system according to claim 1, wherein the circuitry is configured to acquire character data from a plurality of external data sources having different data formats, apply a format normalization algorithm to convert the character data from each external data source into a uniform input format, and generate prompt sentences from the normalized character data.

18. A system comprising:
circuitry configured to:
acquire, via a communication interface coupled to a packet-switched network, character data from an external data source, generate a prompt sentence specifying translation processing instructions, and input the prompt sentence and the character data to a generative neural network model to receive translation data;
associate the translation data with corresponding original character data in a storage device, and transmit both the original character data and the translation data to a terminal device for parallel or switchable display;
analyze emotional state data associated with a user of the terminal device and adjust at least one of a content of the prompt sentence or an output format of the translation data based on a result of the analysis; and
set at least one of a control parameter or an operation setting value of the generative neural network model based on operational characteristics or evaluation data to reduce a probability of erroneous output data generation.

19. The system according to claim 18, wherein the circuitry is configured to apply a hallucination detection algorithm to the received translation data, flag translation data items containing unrecognized entity terms, and regenerate flagged translation data items by supplying a correction prompt sentence to the generative neural network model.

20. A method performed by circuitry, the method comprising:
acquiring, via a communication interface coupled to a packet-switched network, character data from an external data source, and generating, for each item of the character data, a prompt sentence that specifies translation processing instructions for a generative neural network model;
inputting the prompt sentence and the character data to the generative neural network model, and receiving translation data output by the generative neural network model;
associating the translation data with corresponding original character data in a structured storage architecture of a storage device, and controlling transmission of both the original character data and the translation data to a terminal device such that the terminal device performs parallel or switchable display of the original character data and the translation data;
analyzing emotional state data or reaction data associated with a user of the terminal device, and adjusting at least one of a content of the prompt sentence or an output format of the translation data based on a result of the analysis; and
setting at least one of a description content of the prompt sentence, a control parameter, or an operation setting value of the generative neural network model based on operational characteristics, statistical data, or evaluation data of the generative neural network model to reduce a probability that erroneous output data is generated.
